(19) United States
(12) Patent Application Publication
(10) Pub. No.: US 2017/0372864 A1
(43) Pub. Date: Dec. 28, 2017

(54) X-RAY TUBE DEVICE

(71) Applicant: Toshiba Electron Tubes & Devices Co., Ltd., Otawara-shi (JP)

(72) Inventors: Hidero ANNO, Otawara (JP); Tomonari ISHIHARA, Otawara (JP)

(73) Assignee: Toshiba Electron Tubes & Devices Co., Ltd., Otawara-shi (JP)

(21) Appl. No.: 15/686,651

(22) Filed: Aug. 25, 2017

Related U.S. Application Data
(63) Continuation of application No. PCT/JP2016/052526, filed on Jan. 28, 2016.

(30) Foreign Application Priority Data
Feb. 27, 2015 (JP) 2015-037843

(51) Int. Cl. H01J 35/14; H01J 35/10; H01J 35/06; H01J 35/16

(52) U.S. Cl. CPC H01J 35/14; H01J 35/16; H01J 35/105; H01J 35/06; H01J 2235/1204; H01J 2235/18

(57) ABSTRACT

According to one embodiment, an X-ray tube device includes an anode target including a target surface and a cathode including a plurality of electron generation sources configured to emit the electrons, a vacuum envelope configured to house the cathode and the anode target and internally sealed in a vacuum airtight manner, and a quadrupole magnetic-field generator configured to form a magnetic field by being supplied with a current from a power source, the quadrupole magnetic-field generator being installed on an outer side of the vacuum envelope and constituted of a quadrupole surrounding a periphery of electron orbits of the electrons emitted simultaneously from each of the plurality of electron generation sources.

### CROSS-REFERENCE TO RELATED APPLICATIONS

This application is a Continuation Application of PCT Application No. PCT/JP2016/052526, filed Jan. 28, 2016 and based upon and claiming the benefit of priority from Japanese Patent Application No. 2015-037843, filed Feb. 27, 2015, the entire contents of all of which are incorporated herein by reference.

### FIELD

Embodiments described herein relate generally to an X-ray tube device.

### BACKGROUND

In the fields of medical diagnosis devices and non-destructive testing, testing such as X-ray transmission image photographing and X-ray CT (Computed Tomography) which uses an X-ray tube device is widely conducted.

In recent years, in the field of CT, a technique of dual energy imaging has been gathering attention. The dual energy imaging is an imaging technique utilizing a variation in attenuation of a substance in accordance with the average energy of X rays. Depending on two different tube voltages (for example, 140 kV and 80 kV), tissues, for example, a bone, a contrast medium, fat, and a soft tissue exhibit differences in contrast which are dependent on tissue compositions, and thus, the tissues can be imaged so as to be appropriately separated from one another. One of necessary conditions for the dual energy images is application of a sufficient dose to a low energy side in such a manner that images taken with different levels of X-ray energy have equivalent image quality. With low energy, that is, with a low tube voltage, an electron emission surface of a filament has a low field intensity. Thus, in this case, a filament temperature at which the same tube current is obtained needs to be set higher than in the case of a high tube voltage. As a result, a problem occurs in which an operating temperature of the filament increases to shorten the life of the filament. As a method for improving a tube current when a single filament provides an insufficient tube current, a method has been disclosed in which two filaments are prepared and simultaneously operated to generate two electron beams so as to form one small focus on an anode target (for example, Patent Literatures 1 and 2). Utilization of this method as means for solving the above-described problem can easily be envisaged.

Literatures related to the above-described technique are listed below and the entire contents thereof are incorporated herein by reference.

### BRIEF DESCRIPTION OF THE DRAWINGS

FIG. 1 is a cross-sectional view showing an example of an X-ray tube device of a first embodiment.

FIG. 2A is a cross-sectional view schematically showing an X-ray tube of the first embodiment.

FIG. 2B is a cross-sectional view taken along an IIA-IIA line in FIG. 2A.

FIG. 2C is an enlarged view of a cathode of the first embodiment.

FIG. 2D is a cross-sectional view taken along an IIB1-IIB1 line in FIG. 2B.

FIG. 3 is a cross-sectional view showing a principle of a quadrupole magnetic-field generator of the first embodiment.

FIG. 4A is a cross-sectional view schematically showing an X-ray tube of a modification example 1 of the first embodiment.

FIG. 4B is a diagram of a cathode of the modification example 1 of the first embodiment.

FIG. 4C is a cross-sectional view taken along an IVA-IVA line in FIG. 4A.

FIG. 5 is a diagram schematically showing an X-ray tube of a second embodiment.

FIG. 6A is a diagram showing a principle of a dipole magnetic field of the second embodiment.

FIG. 6B is a diagram showing a principle of a quadrupole magnetic-field generator of the second embodiment.

FIG. 7A is a cross-sectional view schematically showing an X-ray tube of a modification example 2 of the second embodiment.

FIG. 7B is a cross-sectional view taken along a VIIA2-VIIA2 line in FIG. 7A.

FIG. 7C is a cross-sectional view taken along a VIIA1-VIIA1 line in FIG. 7A.

FIG. 8A is a diagram showing a principle of a quadrupole magnetic field of the modification example 2 of the second embodiment.

FIG. 8B is a diagram showing a principle of a dipole magnetic field of the modification example 2 of the second embodiment.

FIG. 8C is a diagram showing a principle of a quadrupole magnetic-field generator of the modification example 2 of the second embodiment.

FIG. 9 is a cross-sectional view schematically showing an example of an X-ray tube device of a third embodiment.

FIG. 10A is a cross-sectional view schematically showing an X-ray tube of the third embodiment.

FIG. 10B is a cross-sectional view taken along an XA-XA line in FIG. 10A.

FIG. 10C is a cross-sectional view taken along an XB1-XB1 line in FIG. 10B.

FIG. 10D is a cross-sectional view taken along an XB2-XB2 line in FIG. 10B.

FIG. 10E is a cross-sectional view taken along an XD-XD line in FIG. 10D.

FIG. 11A is a diagram showing a principle of a quadrupole magnetic field of a third embodiment.

FIG. 11B is a diagram showing a principle of a dipole of the third embodiment.

### DETAILED DESCRIPTION

In general, according to one embodiment, an X-ray tube device comprises: an anode target comprising a target surface bombarded by electrons to generate X rays and a cathode comprising a plurality of electron generation sources configured to emit the electrons; a vacuum envelope configured to house the cathode and the anode target and internally sealed in a vacuum airtight manner; and a quadrupole magnetic-field generator configured to form a magnetic field by being supplied with a current from a power source, the quadrupole magnetic-field generator being installed on an outer side of the vacuum envelope and constituted of a quadrupole surrounding a periphery of electron orbits of the electrons emitted simultaneously from each of the plurality of electron generation sources.

An X-ray tube device according to embodiments will be described below in detail with reference to the drawings.

### First Embodiment

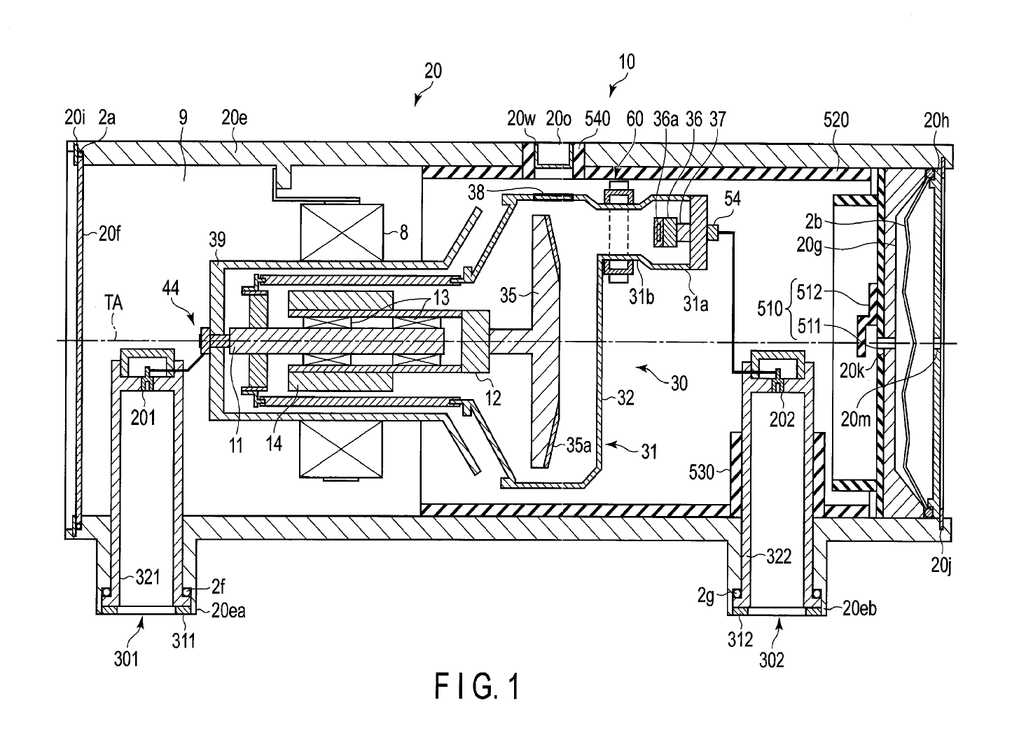

FIG. 1 is a cross-sectional view showing an example of an X-ray tube device 10 of a first embodiment.

As shown in FIG. 1, the X-ray tube device 10 of the first embodiment roughly includes a stator coil 8, a housing 20, an X-ray tube 30, a high-voltage insulating member 39, a quadrupole magnetic-field generator 60, receptacles 301, 302, and X-ray shielding portions 510, 520, 530, 540. For example, the X-ray tube device 10 is a rotating anode-side X-ray tube device. The X-ray tube 30 is, for example, a rotating anode type X-ray tube. For example, the X-ray tube 30 is a neutral grounding type rotating anode type X-ray tube. Each of the X-ray shielding portions 510, 520, 530, and 540 is formed of lead.

In the X-ray tube device 10, insulating oil 9 that is a cooling liquid is stored in a space formed between an inner side of the housing 20 and an outer side of the X-ray tube 30. For example, the X-ray tube device 10 is configured to circulate the insulating oil 9 using a circulative cooling system (cooler) (not shown in the drawings) connected to the housing 20 via a hose (not shown in the drawings). In this case, the housing 20 includes an introduction port and a discharge port for the insulating oil 9. The circulative cooling system includes, for example, a cooler which radiates heat from the insulating oil 9 and which circulates the insulating oil 9 and conduits (hoses or the like) coupling the cooler to the introduction port and discharge port of the housing 20 in a liquid and air tight manner. The cooler has a circulating pump and a heat exchanger. The circulating pump discharges the insulating oil drawn from the housing 20 side to the heat exchanger, forming a flow of the insulating oil 9 in the housing 20. The heat exchanger is coupled to between the housing 20 and the circulating pump to emit heat of the insulating oil to the outside.

A configuration of the X-ray tube device 10 will be described below with reference to the drawings.

The housing 20 is provided with a housing main body 20e formed like a tube and covers (side plates) 20f, 20g, 20h. The housing main body 20e and covers 20f, 20g, 20h are formed of casting using aluminum. If a resin material is used, metal may also be partly used for areas such as threaded parts which need strength, areas which are difficult to form by injection molding of resin, a shielding layer (not shown in the drawings) which prevents leakage of electromagnetic noise to the outside of the housing 20, and the like. Here, a central axis passing through the center of circle of the cylinder of the housing main body 20e is referred to as a tube axis TA.

An annular step portion is formed in an opening portion of the housing main body 20e as an inner circumferential surface having a smaller thickness than the housing main body 20e. An annular groove portion is formed along the inner circumference of the step portion. The groove portion is formed, by machining, at a position located outward of the step of the step portion at a predetermined length therefrom along the tube axis TA. Here, the predetermined length is, for example, substantially equivalent to the thickness of the cover 20f. A C-type retaining ring 20i is fitted into the groove portion of the housing main body 20e. That is, the opening portion of the housing main body 20e is occluded by the cover 20f, the C-type retaining ring 20i, and the like in a liquid-tight manner.

The cover 20f is shaped like a disc. The cover 20f is provided with a rubber member j2a along an outer circumferential portion and fitted on the step portion formed in the opening portion of the housing main body 20e.

The rubber member 2a is shaped, for example, like an O ring. As described above, the rubber member 2a is provided between the housing main body 20e and the cover 20f to provide a liquid tight seal between the housing main body 20e and the cover 20f. In a direction along the tube axis TA of the X-ray tube device, a peripheral portion of the cover 20f contacts the step portion of the housing main body 20e.

The C-type retaining ring 20i is a fixing member. In order to stop the cover 20f from moving in a direction along the tube axis TA, the C-type retaining ring 20i is fitted into the groove portion of the housing main body 20e as described above to fix the cover 20f.

The cover 20g and the cover 20h are fitted into an opening portion of the housing main body 20e opposite to the opening portion thereof where the cover 20f is installed. That is, the cover 20g and the cover 20h are installed at an end of the housing main body 20e opposite to the end thereof where the cover 20f is installed, so as to lie parallel and opposite to each other. The cover 20g is fitted at a predetermined inner position of the housing main body 20e and provided in a liquid-tight manner. At the end of the housing main body 20e where the cover 20h is installed, an annular groove portion is formed in an outer inner circumferential portion adjacent to the installation position of the cover 20h. A rubber member 2b is installed between the cover 20g and the cover 20h so as to maintain the liquid tightness in a stretchable manner. The cover 20h is provided outward of the cover 20g in the housing main body 20e. A C-type retaining ring 20j is fitted into the groove portion. That is, the opening portion of the housing main body 20e is occluded by the cover 20g, the cover 20h, the C-type retaining ring 20j, the rubber member 2b, and the like in a liquid tight manner.

The cover 20g is shaped like a circle having substantially the same diameter as that of the outer circumference of the housing main body 20e. The cover 20g is provided with an opening portion 20k through which the insulating oil 9 is injected and discharged.

The cover 20h is shaped like a circle having substantially the same diameter as that of the inner circumference of the housing main body 20e. The cover 20h is provided with a vent hole 20m through which air as atmosphere enters and exits.

The C-type retaining ring 20j is a fixing member which maintains a state where the cover 20h is compressed against a peripheral portion (seal portion) of the rubber member 2b.

The rubber member 2b is a rubber bellows (rubber film). The rubber member 2b is shaped like a circle. Furthermore, the peripheral portion (seal portion) of the rubber member 2b is shaped like an O ring. The rubber member 2b is provided between the housing main body 20e and the cover 20g and the cover 20h to seal spaces between the housing main body 20e and the cover 20g and the cover 20h in a liquid-tight manner. The rubber member 2b is installed along an inner circumference of the end of the housing main body 20e. That is, the rubber member 2b is provided to isolate a partial space in the housing. In the present embodiment, the rubber member 2b is installed in the space surrounded by the cover 20g and the cover 20h to separate the space into two parts in a liquid-tight manner. Here, the cover 20g-side space is referred to as a first space, and the cover 20h-side space is referred to as a second space. The first space is joined, via the opening 20k, to a space on the inner side the housing main body 20e which is filled with the insulating oil 9. Thus, the first space is filled with the insulating oil 9. The second space is joined to an external space via the vent hole 20m. Thus, the second space is an air atmosphere.

The housing main body 20e is provided with an opening 20o which partly penetrates the housing main body 20e. An X-ray radiation window 20w and the X-ray shielding portion 540 are installed in the opening 20o. The opening portion 20o is occluded by the X-ray radiation window 20w and the X-ray shielding portion 540 in a liquid-tight manner. As described below in detail, the X-ray shielding portions 520 and 540 are installed to shield against X ray radiation to the outside of the housing 20 through the opening 20o.

The X-ray radiation window 20w is formed of a member which allows X rays to pass through. For example, the X-ray radiation window 20w is formed of a metal which allows X rays to pass through.

The X-ray shielding portions 510, 520, 530, and 540 may be formed of an X-ray transmission material containing at least lead and may be formed of a lead alloy or the like.

The X-ray shielding portion 510 is provided on an inner surface of the cover 20g. The X-ray shielding portion 510 shields against X rays radiated from the X-ray tube 30. The X-ray shielding portion 510 is provided with a first shielding portion 511 and a second shielding portion 512. The first shielding portion 511 is joined to an inner surface of the cover 20g. The first shielding portion 511 is installed so as to cover the entire inner surface of the cover 20g. Furthermore, the second shielding portion 512 is installed in such a manner that a first end portion thereof is stacked on an inner surface of the first shielding portion 511, and a second end portion thereof is arranged at a distance from the opening 20k toward the inner side of the housing main body 20e in a direction along the tube axis TA. That is, the second shielding portion 512 is installed in such a manner that the insulating oil 9 can flow in and out via the opening portion 20k.

The X-ray shielding portion 520 is shaped generally like a cylinder. The X-ray shielding portion 520 is installed on a portion of the inner circumferential portion of the housing main body 20e. A first end of the X-ray shielding portion 520 is in proximity to the first shielding portion 511. This allows shielding against X rays which may exit through a gap between the X-ray shielding portion 510 and the X-ray shielding portion 520. The X-ray shielding portion 520 is shaped like a tube and extends along the tube axis from the first shielding portion 511 to the vicinity of the stator coil 8. In the present embodiment, the X-ray shielding portion 520 extends from the first shielding portion 511 to the front of the stator coil 8. The X-ray shielding portion 520 is fixed to the housing 20 as needed.

The X-ray shielding portion 530 is shaped like a tube and fitted along an outer circumference of a receptacle 302 located inside the housing 20 and described below. The X-ray shielding portion 530 is provided in such a manner that a first end portion of the cylinder contacts a wall surface of the housing main body 20e. In this case, the X-ray shielding portion 520 is provided with a hole through which the first end portion of the X-ray shielding portion 530 is passed. The X-ray shielding portion 530 is fixed to an outer circumference of the receptacle 302 described below, as needed.

The X-ray shielding portion 540 is shaped like a frame and provided at a side edge of the opening portion 20o of the housing 20. The X-ray shielding portion 540 is installed along an inner wall of the opening portion 20o. An end of the X-ray shielding portion 540 on the inner side of the housing main body 20e contacts the X-ray shielding portion 520. The X-ray shielding portion 540 is fixed to the side edge of the opening portion 20o as needed.

The receptacle 301 for the anode and the receptacle 302 for the cathode are each connected to the housing main body 20e. Each of the receptacles 301, 302 is shaped like a bottomed tube provided with an opening portion. Each of the receptacles 301, 302 has a bottom portion installed inside the housing 20 and the opening portion is open toward the outer side. For example, the receptacles 301, 302 are installed at a predetermined distance from each other in the housing main body 20e in such a manner that the opening portions of the receptacles 301, 302 face the same direction.

A Plug (not shown in the drawings) which is inserted into the receptacle 301 and the receptacle 301 are of a non-surface-pressure type and are removably formed. With the plug coupled to the receptacle 301, a high voltage (for example, +70 to +80 kV) is supplied to a terminal 201 through the plug.

The receptacle 301 is installed on the cover 20f side of the housing 20 and inward of the cover 20f. The receptacle 301 has a housing 321 as an electric insulating member and the terminal 20 as a high-voltage supply terminal.

The housing 321 is formed of an insulating material, for example, resin. The housing 321 is shaped like a bottomed cylinder and has a plug slot which is open to the outer side. The housing 321 is provided with the terminal 201 at a bottom portion thereof. The housing 321 is provided with an annular protruding portion on an outer surface of an opening-side end of the housing 321. The protruding portion of the housing 321 is formed to be fitted into a step portion 20ea which is a step formed at an end portion of a protruding portion of the housing main body 20e. The terminal 201 is attached to the bottom portion of the housing 321 in a liquid-tight manner and penetrates the above-described bottom portion. A terminal 401 is connected to a high-voltage supply terminal 44 described below, via an insulating coated wire.

Furthermore, a rubber member 2f is provided between the protruding portion of the housing 321 and the housing main body 20e. The rubber member 2f is installed between the protruding portion of the housing 321 and a step portion of the step portion 20ea to provide a liquid tight seal between the protruding portion of the housing 321 and the housing main body 20e. In the present embodiment, the rubber member 2f is formed of an O ring. The rubber member 2f prevents leakage of the insulating oil 9 to the outside of the housing 20. The rubber member 2f is formed of, for example, sulfur vulcanizable rubber.

The housing 321 is fixed by a ring nut 311. The ring nut 311 is provided with a threaded groove in an outer circumferential portion thereof. For example, the outer circumferential portion of the ring nut 311 is machined into an external thread, and an inner circumferential portion of the step portion 20ea is machined into an internal thread. Therefore, screwing the ring nut 311 allows the protruding portion of the housing 321 to be pressed against the step portion 20ea via the rubber member 2f. As a result, the housing 321 is fixed to the housing main body 20e.

The receptacle 302 is installed on the cover 20g side of the housing 20 and inward of the cover 20g. The receptacle 302 is formed substantially equivalently to the receptacle 301. The receptacle 302 has a housing 322 as an electric insulating member and a terminal 202 as a high-voltage supply terminal.

The housing 322 is formed of an insulating material, for example, resin. The housing 322 is shaped like a bottomed cylinder and has a plug slot which is open to the outer side. The housing 322 is provided with the terminal 201 at a bottom portion thereof. The housing 322 is provided with an annular protruding portion on an outer surface of an opening-side end of the housing 322. The protruding portion of the housing 322 is formed to be fitted into a step portion 20eb which is a step formed at an end portion of a protruding portion of the housing main body 20e. The terminal 202 is attached to the bottom portion of the housing 321 in a liquid-tight manner and penetrates the above-described bottom portion. The terminal 202 is connected to a high-voltage supply terminal 54 described below, via an insulating coated wire.

Furthermore, a rubber member 2g is provided between the protruding portion of the housing 322 and the housing main body 20e. The rubber member 2g is installed between the protruding portion of the housing 322 and a step portion of the step portion 20eb to provide a liquid tight seal between the protruding portion of the housing 321 and the housing main body 20e. In the present embodiment, the rubber member 2g is formed of an O ring. The rubber member 2g prevents leakage of the insulating oil 9 to the outside of the housing 20. The rubber member 2g is formed of, for example, sulfur vulcanizable rubber.

The housing 322 is fixed by a ring nut 312. The ring nut 312 is provided with a threaded groove in an outer circumferential portion thereof. For example, the outer circumferential portion of the ring nut 312 is machined into an external thread, and an inner circumferential portion of the step portion 20eb is machined into an internal thread. Therefore, screwing the ring nut 312 allows the protruding portion of the housing 322 to be pressed against the step portion 20eb via the rubber member 2g. As a result, the housing 322 is fixed to the housing main body 20e.

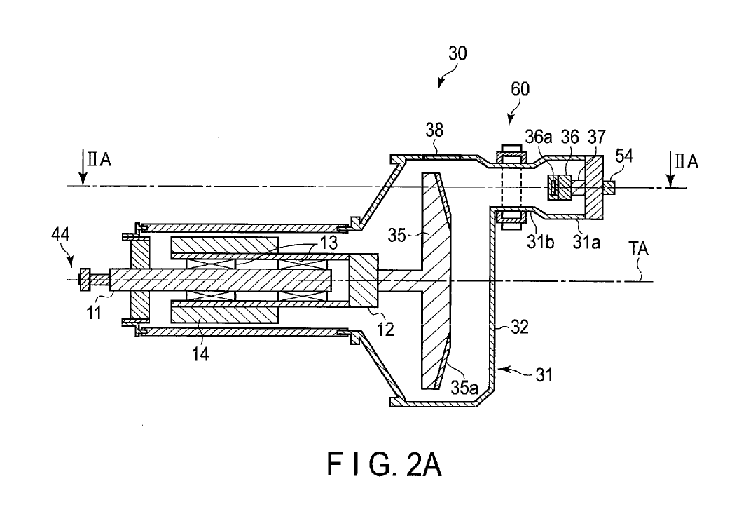

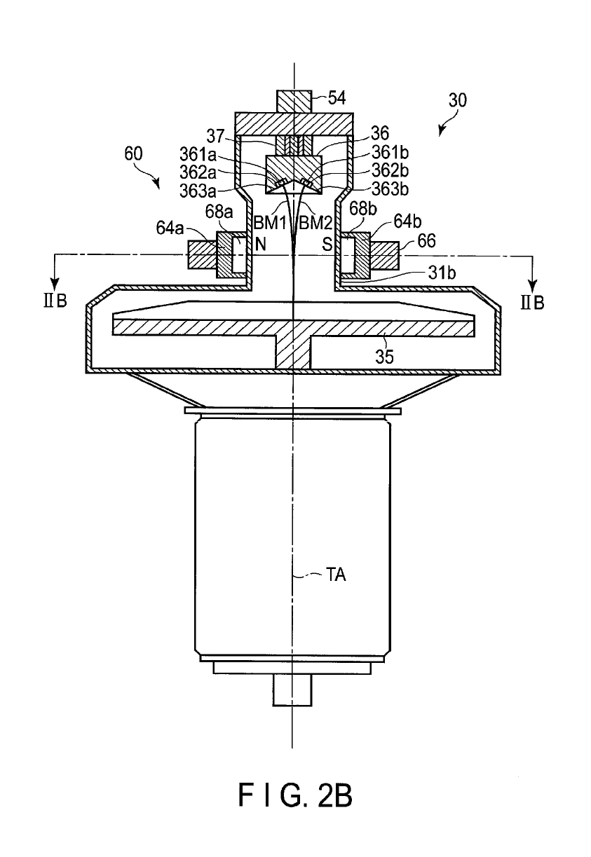

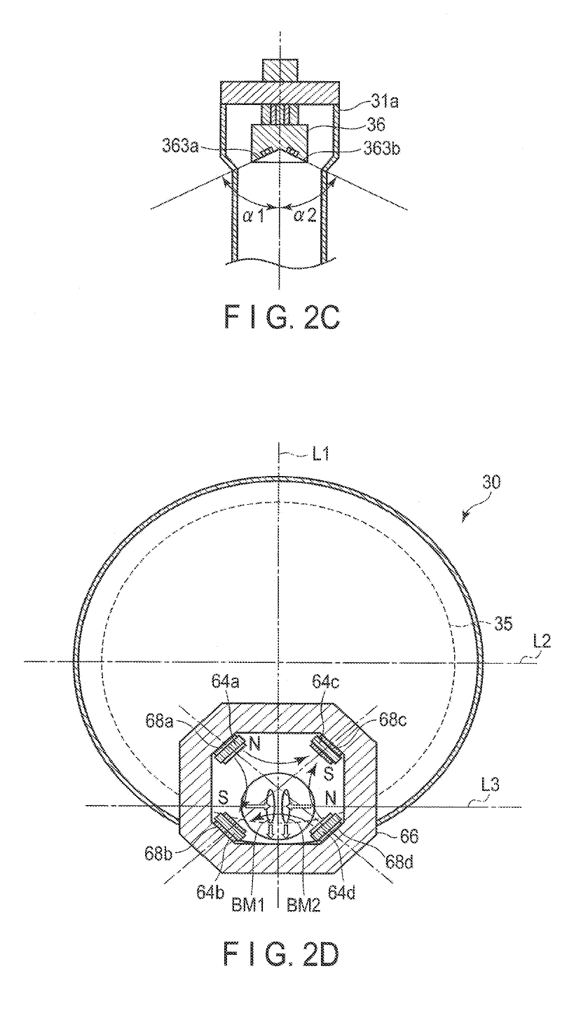

FIG. 2A is a cross-sectional view schematically showing the X-ray tube 30 of the first embodiment. FIG. 2B is a cross-sectional view taken along an IIA-IIA line in FIG. 2A. FIG. 2C is an enlarged view of the cathode of the first embodiment. FIG. 2D is a cross-sectional view taken along an IIB-IIB line in FIG. 2B. In FIG. 2D, a straight line which is orthogonal to the tube axis TA is designated as a straight line L1, and a straight line which is orthogonal to the tube axis TA and the straight line L1 is designated as a straight line L2.

The X-ray tube 30 is provided with a fixed shaft, a rotating body 12, a bearing 13, a rotor 14, a vacuum envelope 31, a vacuum container 32, an anode target 35, a cathode 36, the high-voltage supply terminal 44, and the high-voltage supply terminal 54.

In FIG. 2D, a straight line which is orthogonal to a straight line passing through the center of the cathode 36 and which is parallel to the straight line L2 is designated as a straight line L3.

The fixed shaft 11 is shaped like a cylinder. The fixed shaft 11 rotatably supports the rotating body 12 via the bearing 13. The fixed shaft is provided, at a first end thereof, with a protruding portion attached to the vacuum envelope 31 in a liquid-tight manner. The protruding portion of the fixed shaft 11 is fixed to the high-voltage insulating member 39. In this case, a tip portion of the protruding portion of the fixed shaft 11 penetrates the high-voltage insulating member 39. The high-voltage supply terminal 44 is electrically connected to the tip portion of the protruding portion of the fixed shaft 11.

The rotating body 12 is shaped like a bottomed tube. The fixed shaft 11 is inserted into the rotating body. 12 so that the rotating body 12 is installed coaxially with the fixed shaft 11. The rotating body 12 is connected to the anode target 35 described below at a bottom portion-side tip portion thereof and is provided so as to be rotatable along with the anode target 35.

The bearing 13 is installed between an inner circumferential portion of the rotating body and an outer circumferential portion of the fixed shaft 11.

The rotor 14 is provided so as to lie on an inner side of the stator coil 8 shaped like a cylinder.

The high-voltage supply terminal 44 applies a relatively positive voltage to the anode target 35 via the fixed shaft 11, the bearing 13, and the rotating body 12. The high-voltage supply terminal 44 is connected to the receptacle 301 and supplied with a current when a high-voltage supply source such as a plug not shown in the drawings is connected to the receptacle 301. The high-voltage supply terminal 44 is a metal terminal.

The anode target 35 is shaped like a disc. The anode target 35 is connected to the bottom portion-side tip portion of the rotating body 12 coaxially with the rotating body 12. For example, the rotating body 12 and the anode target 35 are installed in such a manner that center axes thereof extend along the tube axis TA. That is, the axes of the rotating body 12 and the anode target 35 are parallel to the tube axis TA. In this case, the rotating body 12 and the anode target 35 are provided so as to be rotatable around the tube axis TA.

The anode target 35 has an umbrella-shaped target layer 35a provided in a portion of an outer surface of the anode target. The target layer 35a emits X rays by being bombarded by electrons emitted from the cathode 36. An outer surface of the anode target 35 and a surface of the anode target 35 opposite to the target layer 35a are blackened. The anode target 35 is formed of a member which is a nonmagnetic substance and has a high electric conductivity (electric conduction property). For example, the anode target 35 is formed of copper, tungsten, molybdenum, niobium, tantalum, nonmagnetic stainless steel, or the like. The anode target 35 may be configured in such a manner that at least a surface portion thereof is formed of a metal member which is a nonmagnetic substance and which has a high electric conductivity. Alternatively, the anode target 35 may be configured in such a manner that the surface portion thereof is coated with a coating member formed of a metal member which is a nonmagnetic substance and which has a high electric conductivity.

When arranged in an AC magnetic field, the nonmagnetic substance allows lines of magnetic force resulting from the action of an opposite AC magnetic field based on an eddy current to be more intensively distorted in a case where the electric conductivity is high than in a case where the electric conductivity is low. Since the lines of magnetic force are thus distorted, the lines of magnetic force flow along a surface of the anode target 35 even if the quadrupole magnetic-field generator 60 described below is in proximity to the anode target 35 and the quadrupole magnetic-field generator 60 generates an AC magnetic field. Thus, the magnetic field (AC magnetic field) in the vicinity of the surface of the anode target 35 is intensified.

The cathode 36 is provided at a position opposed to the target layer 35a. The cathode 36 is installed at a predetermined distance from the surface of the anode target 35. The cathode 36 emits electrons to the anode target 35. For example, the cathode 36 is shaped like a cylinder and emits electrons to the surface of the anode target 35 through a filament provided at the center of the circle of the cylinder. In this case, a straight line passing through the center of the cathode 36 is parallel to the tube axis TA. The directions of electrons emitted from the cathode 36 and orbits of the electrons may hereinafter be described as electron orbits. A relatively negative voltage is applied Lo the cathode 36. The cathode 36 is attached to a cathode support portion (cathode support body, cathode support member) 37 described below and connected to the high-voltage supply terminal 54 passing through the inside of the cathode support portion 37. The cathode 36 may be referred to as an electron generation source. The center of the cathode 36 may hereinafter include a straight line passing through the center.

The cathode 36 is provided with a plurality of filaments (hereinafter referred to as filaments) 361a, 361b, a plurality of converging grooves (hereinafter referred to as converging grooves (converging groove portions)) 362a, 362b, and a plurality of converging surfaces (hereinafter referred to as converging surfaces) 363a, 363b.

When a negative high voltage is applied to each of the filaments 361a and 361b, the filament emits electrons (beams). For example, each of the filaments 361a and 361b is a filament for a small focus. Furthermore, each of the filaments 361a, 361b is provided with a converging electrode around a periphery thereof to converge emitted electron beams. For example, as shown in FIG. 2A, each of the filaments 361a, 361b is shaped to be elongate in a direction perpendicular to the central axis of the cathode 36, for example, shaped like a rectangle. Each of the filaments 361a, 361b may be formed to have a circular shape, a square shape, or any other shape. Furthermore, each of the filaments 361a, 361b may be a coil filament or a planar filament.

Each of the converging grooves 362a, 362b is formed by hollowing out an anode target 35-side portion of the cathode 36 into a rectangular groove. The converging grooves 362a, 362b are obtained by forming the converging surfaces 363a, 363b described below into recessed shapes. The converging grooves 362a, 362b house the filaments 361a, 361b, respectively. In this case, in the focusing grooves 362a, 362b, each of the filaments 361a, 361b is provided in the center of the corresponding groove, and a focusing electrode is installed along an inner circumference of the groove.

Each of the converging surfaces 363a, 363b is an anode target 35-side end face of the cathode 36 formed to allow the foci of a plurality of electron beams to overlap on the anode target 35. For example, the converging surfaces 363a, 363b are formed to incline symmetrically with respect to the central axis of the cathode 36. In this case, the filaments 361a, 361b and the converging grooves (converging groove portions) 362a, 362b are provided symmetrically with respect to the central axis of the cathode 36. The shapes and angles of the converging surfaces 363a, 363b are changed as needed in accordance with a distance between the filaments 361a, 361b and the anode target 35, the size of the filaments 361a, 361b, and the like. The converging surfaces 363a, 363b are advantageous in terms of tube current characteristics, and are thus preferably set at as shallow an angle as possible with respect to a plane parallel to a surface (tip surface) of the cathode 36 opposed to the anode target 35.

Here, the shallow angle of the converging surfaces 363a, 363b indicates that, in FIG. 2B and FIG. 2C, each of the converging surfaces 363a, 363b is formed at an angle close to parallelism to the tip surface. Furthermore, the deep angle of the converging surfaces 363a, 363b indicates that, in FIG. 2B and FIG. 2C, each of the converging surfaces 363a, 363b is formed at an angle close to parallelism to the central axis of the cathode 36.

In FIG. 2C, an emission angle which is an inclination angle from the central axis of the cathode 36 to the converging surface 363a is referred to as al, and an emission angle which is an inclination angle from the central axis of the cathode 36 to the converging surface 363b is referred to as α2. Each of the emission angles α1 and α2 is set to form the focus of a plurality of electron beams at a desired position with the action of a magnetic field from the quadrupole magnetic-field generator 60 taken into account. That is, the converging surfaces 363a, 363b of the cathode 36 are formed at predetermined emission angles α1 and α2 so as to form a focus at the desired position. For example, the emission angles α1 and α2 are formed in such a manner that 45°<α1<90° and 45°<α2<90°. Suitably, the emission angles α1 and α2 are formed in such a manner that 50°<α1<70° and 50°<α2<70°. Such setting of the emission angles α1 and α2 is known to allow a plurality of electron beams to overlap without being enlarged.

Electron (emitted thermal electron) beams emitted from the filaments travel from the converging electrodes to the anode in circles. Thus, if the distance between the converging grooves 362a, 362b and the anode target 35 is far, the angle of the inclined surface of each of the converging surfaces 363a, 363b is shallow with respect to the plane parallel to the central axis (or a deep angle with respect to the central axis). If the distance between the converging grooves 362a, 362b and the anode target 35 is near, the angle is deep with respect to the plane parallel to the central axis (or a shallow angle with respect to the central axis). On the other hand, the distance between the converging electrodes and the anode target 35 is set to a minimum distance needed to avoid high-voltage breakdown. In terms of avoidance of high-voltage breakdown, this distance is advantageously far. However, if the distance is far, the rate at which electron beams from the filaments arrive at the anode target 35 decreases, resulting in disadvantageous tube current characteristics (a prescribed tube current is not obtained without an extra increase in filament current, leading to a shortened life of the filaments).

The cathode support portion 37 has a first end portion provided with the cathode 36 and a second end portion connected to an inner wall of the vacuum envelope 31 (vacuum container 32). Furthermore, the cathode 36 is internally provided with the high-voltage supply terminal 54. As shown in FIG. 2A, the cathode support portion 37 extends from an inner wall surface of the vacuum envelope 31 (vacuum container 32) to a surface of the cathode 36 toward the anode target 35. For example, the cathode support portion 37 is shaped like a cylinder and provided coaxially with the cathode 36. In this case, the cathode support portion 37 has a first end face connected to a surface of the vacuum envelope 31 (vacuum container 32) and a second end face connected to the surface of the cathode 36.

The cathode 36 is provided with a nonmagnetic-substance cover which covers the entire outer circumference. The nonmagnetic-substance cover is provided like a cylinder so as to enclose a periphery of the cathode 36. The nonmagnetic-substance cover is formed of a nonmagnetic metal material such as one of copper, tungsten, molybdenum, niobium, tantalum, and nonmagnetic stainless steel, or a metal material the principal ingredient of which is one of these materials. Suitably, the nonmagnetic-substance cover is formed of a member with a high electric conductivity. When arranged in an AC magnetic field, the nonmagnetic-substance cover allows lines of magnetic force resulting from the action of the opposite AC magnetic field based on the eddy current to be more intensively distorted in the case where the electric conductivity is high than in the case where the electric conductivity is low. Since the lines of magnetic force are thus distorted, the lines of magnetic force flow along the periphery of the cathode 36 even if the quadrupole magnetic-field generator 60 described below is in proximity to the cathode 36 and the quadrupole magnetic-field generator 60 generates an AC magnetic field. Thus, the magnetic field (AC magnetic field) in the vicinity of the surface of the cathode 36 is intensified. At least a surface portion of the cathode 36 may be formed of a metal member which has a high electric conductivity and which is a nonmagnetic substance.

The high-voltage supply terminal 54 has a first end portion connected to the cathode 36 through the inside of the cathode support portion 37 and a second end portion connected to the receptacle 301. The high-voltage supply terminal 54 supplies a current to the cathode 36 when a high-voltage supply source such as a plug is connected to the receptacle 302. The high-voltage supply terminal 54 is a metal terminal. The high-voltage supply terminal 54 applies a relatively negative voltage to the cathode 36, while supplying a filament current to the filaments (electron radiation source) of the cathode 36, not shown in the drawings.

The vacuum envelope 31 is sealed in a vacuum atmosphere (vacuum airtight atmosphere) to internally house the fixed shaft 11, the rotating body 12, the bearing 13, the rotor 14, the vacuum container 32, the anode target 35, the cathode 36, and the high-voltage supply terminal 54.

The vacuum container 32 is provided with an X-ray transmission window 38 in a vacuum airtight manner. The X-ray transmission window 38 is provided in a wall portion of the vacuum envelope 31 (vacuum container 32) opposed to a target surface of the anode target 35 located between the cathode 36 and the anode target 35. The X-ray transmission window 38 is formed of metal, for example, beryllium or titanium, stainless steel, and aluminum and provided in a portion of the vacuum container 32 which is opposed to the X-ray radiation window 20w. For example, the vacuum container 32 is hermetically occluded by the X-ray transmission window 38 formed of beryllium as a member which allows X rays to pass through.

In the vacuum envelope 31, the high-voltage insulating member 39 is arranged from the high-voltage supply terminal 44 side to the periphery of the anode target 35. The high-voltage insulating member 39 is formed of an electric insulating resin.

The vacuum envelope 31 (vacuum container 32) is provided with a housing portion 31a in which the cathode 36 is installed. The housing portion 31a is provided with a small diameter portion 31b in a portion thereof between the anode target 35 and the cathode 36 in such a manner that the small diameter portion 31b has a reduced diameter. For example, the housing portion 31a is shaped like a cylinder. The housing portion 31a is a portion of the vacuum envelope 31 and extends from the vicinity of the X-ray transmission window 38 toward the outer side of the X-ray tube 30 along the direction of a straight line parallel to the tube axis TA. Furthermore, the housing portion 31a is provided so as to be opposed to the surface of the anode target 35. For example, as shown in FIG. 2A, the housing portion 31a is provided so as to be opposed to the surface of a radial end of the anode target 35 and to extend from the vicinity of the X-ray transmission window 38 along the direction of a straight line parallel to the tube axis TA.

The small diameter portion 31b is provided to enhance the action of a magnetic field on a plurality of electron beams emitted from the cathode 36 when the quadrupole magnetic-field generator 60 is installed. The small diameter portion 31b is formed to have a smaller diameter than the peripheral housing portion 31a. As shown in FIG. 2A and FIG. 2B, the small diameter portion 31b is formed between the anode target 35 and the cathode 36 so as to have a smaller diameter than the peripheral housing portion 31a. The small diameter portion 31b is provided so as to form the focus of a plurality of electron beams at the desired position.

Furthermore, the vacuum envelope 31 captures recoil electrons reflected from the anode target 35. Thus, the vacuum envelope 31 is likely to have the temperature thereof raised by the bombardment of recoil electrons and is normally formed of a member such as copper which has a high heat conductivity. The vacuum envelope 31 is desirably constituted of a member which does not generate a diamagnetic field if the vacuum envelope 31 is affected by an AC magnetic field. For example, the vacuum envelope 31 is formed of a metal member which is a nonmagnetic substance. Suitably, the vacuum envelope 31 is formed of a high-voltage resist member which is a nonmagnetic substance so as to inhibit an overcurrent from being generated by an alternating current. The high-voltage resist member which is a nonmagnetic substance is, for example, nonmagnetic stainless steel, inconel, inconel X, titanium, conductive ceramics, or non-conductive ceramics the surface of which is coated with a metal thin film.

The high-voltage insulating member 39 is shaped like a ring having a first end shaped like a cone and a second end which is occluded. The high-voltage insulating member 39 is fixed directly or indirectly to the housing 20 via the stator coil 8 and the like. The high-voltage insulating member 39 electrically insulates the fixed shaft 11 from the housing 20 and the stator coil 8. Thus, the high-voltage insulating member 39 is installed between the stator coil 8 and the fixed shaft 11. That is, the high-voltage insulating member 39 is installed so as to internally house a side of the X-ray tube 30 (vacuum container 32) from which the fixed shaft 11 of the X-ray tube 30 protrudes.

Referring back to FIG. 1, the stator coil 8 is fixed to the housing at a plurality of positions. The stator coil 8 is installed so as to surround an outer circumferential portion of the rotor 14 and the high-voltage insulating member 39. The stator coil 8 rotates the rotor 14, the rotating body 12, and the anode target 35. A predetermined current is supplied to the stator coil 8 to generate a magnetic field provided to the rotor 14, allowing the anode target 35 and the like to rotate at a predetermined speed. That is, when a current is supplied to the stator coil 8, which is a rotational driving device, the rotor 14 rotates and the anode target 35 rotates in conjunction with the rotation of the rotor 14.

A space inside the housing 20 which is surrounded by the rubber bellows 2b, the housing main body 20e, the cover 20f, the receptacle 301, and the receptacle 302 is filled with the insulating oil 9. The insulating oil 9 absorbs at least a portion of heat generated by the X-ray tube 30.

Referring back to FIG. 2A to FIG. 2D, the quadrupole magnetic-field generator 60 will be described.

As shown in FIG. 2B and FIG. 2D, the quadrupole magnetic-field generator 60 is provided with a coil 64 (64a, 64b, 64c, and 64d), a yoke 66, and a magnetic pole 68 (68a, 68b, 68c, and 68d).

The quadrupole magnetic-field generator 60 generates a magnetic field by being supplied with a current from a power source. The quadrupole magnetic-field generator 60 can vary the intensity (magnetic flux density) of a magnetic field generated, the orientation of the magnetic field, and the like based on the intensity or direction of a supplied current, or the like. The quadrupole magnetic-field generator 60 is formed using four poles (or quadrupole) arranged close to one another in such a manner that the adjacent magnetic poles have different polarities. If two adjacent magnetic poles are considered to be one dipole and the remaining two magnetic poles are considered to be another dipole, magnetic fields generated by the two dipoles act in opposite directions. Therefore, the quadrupole magnetic-field generator 60 acts on the shape of each of a plurality of electron beams such as the width and height thereof based on a magnetic field generated. The “width” and “height” of an electron beam are lengths in directions which are both perpendicular to a straight line following an emission direction of each of a plurality of electron beams and which are orthogonal to each other, regardless of a spatial arrangement of the X-ray tube 30. In the present embodiment, the quadrupole magnetic-field generator 60 has four magnetic poles 8 arranged in a square form. As described below in detail, in the quadrupole magnetic-field generator 60, the magnetic poles 68a, 68b, 68c, and 68d are provided on the inner side of the yoke 66 so as to be opposed to one another.

The quadrupole magnetic-field generator 60 is installed in such a manner that the small diameter portion 31b is surrounded by an inner circumferential portion of the yoke 66 described below. The quadrupole magnetic-field generator 60 is eccentrically installed in such a manner that the center of the quadrupole magnetic-field generator 60 does not overlap the central axis of the cathode 36. That is, the quadrupole magnetic-field generator 60 is installed in such a manner that a central position of the quadrupole magnetic-field generator 60 is displaced from (is eccentric to) the central axis of the cathode 36. In this case, the center of the quadrupole magnetic-field generator 60 is substantially the same as the center of the yoke 66 formed by a hollow circle or polygon and described below. For example, as shown in FIG. 2D, the quadrupole magnetic-field generator 60 is installed at a position resulting from movement from a central position of the cathode 36 toward a central position of the anode target 35 in a radial direction (or along the straight line L1). The quadrupole magnetic-field generator 60 may be installed perpendicularly eccentrically to the central axis of the cathode 36 unlike in the description above. Furthermore, the quadrupole magnetic-field generator 60 is installed in association with the emission angles of the above-described converging surfaces 363a, 363b in order to form the focus of a plurality of electron beams at a desired position. In order to form the focus of a plurality of electron beams at the desired position, the quadrupole magnetic-field generator 60 varies the intensity (magnetic flux density) of a magnetic field generated, the orientation of the magnetic field, and the like based on the intensity or direction of a supplied current, or the like in association with the above-described angle.

The coil 64 is supplied with a current from the power source (not shown in the drawings) for the quadrupole magnetic-field generator 60 to generate a magnetic field. For example, the coil 64 is an electromagnetic coil. In the present embodiment, the coil 64 is supplied with a direct current from the power source (not shown in the drawings). The coil 64 is provided with a plurality of coils 64a, 64b, 64c, and 64d. Each of the coils 64a to 64d is wound around a portion of a corresponding one of the magnetic poles 68a, 68b, 68c, and 68d described below.

The yoke 66 is shaped like a hollow polygon or a hollow cylinder. The yoke 66 is formed of, for example, a high electric resistor which is a soft magnetic substance and which is unlikely to generate an eddy current in spite of an AC magnetic field. The yoke 66 is formed of, for example, a laminate obtained by laminating thin plates of an Fe—Si alloy (silicon steel), an Fe—Al alloy, electromagnetic stainless steel, an Fe—Ni high-magnetic-permeability stainless steel such as permalloy, an Ni—Cr alloy, an Fe—Ni—Cr alloy, an Fe—Ni—Co alloy, an Fe—Cr alloy, or the like in such a manner that electric insulating films are sandwiched between the thin plates, or an aggregate obtained by covering wire materials of any of the above-described materials and bundling and binding the resultant wire materials. Alternatively, the yoke 66 may be formed of a compact obtained by forming any of the above-described materials into fine power of approximately 1 μm, covering a surface of the powder with an electric insulating film, and then performing compression molding on the resultant powder. Moreover, the yoke 66 may be formed of soft ferrite or the like.

The magnetic poles 68 are provided with the plurality of magnetic poles 68a, 68b, 68c, and 68d. The magnetic poles 68a, 68b, 68c, and 68d are each provided on an inner circumferential wall of the yoke 66. The magnetic poles 68a to 68d are arranged to surround electron orbits of a plurality of electron beams around the small diameter portion 31b. For example, in the quadrupole magnetic-field generator 60, the magnetic poles 68a to 68d are evenly arranged around the central axis of the cathode 36 at positions perpendicular to the central axis. As shown in FIG. 2D, that is, the magnetic poles 68a to 68d are installed so as to be arranged at positions of vertices of a square. Suitably, in order to increase magnetic flux density, the magnetic poles 68a to 68d are installed close to emission directions (electron orbits) of electrons emitted from the filaments 361a and 361b.

The magnetic poles 68a to 68d are formed to have substantially the same shape. The magnetic poles 68a to 68d include two dipoles each forming a pair. For example, the magnetic pole 68a and the magnetic pole 68b are a dipole (magnetic pole pair 68a, 68b), and the magnetic pole 68c and the magnetic pole 68d are a dipole (magnetic pole pair 68c, 68d). In this case, if a direct current is supplied to the magnetic poles 68 via the coils 64 (64a, 64b, 64c, and 64d), the magnetic pole pair 68a, 68b and the magnetic pole pair 68c, 68d form opposed DC magnetic fields. The magnetic poles 68a to 68d are each installed to face a surface (end face) where a magnetic field is generated with respect to the electron orbits of electron beams in order to deform the shapes of electron beams emitted from the cathode 36.

The principle of the quadrupole magnetic-field generator 60 of the present embodiment will be described below with reference to the drawings.

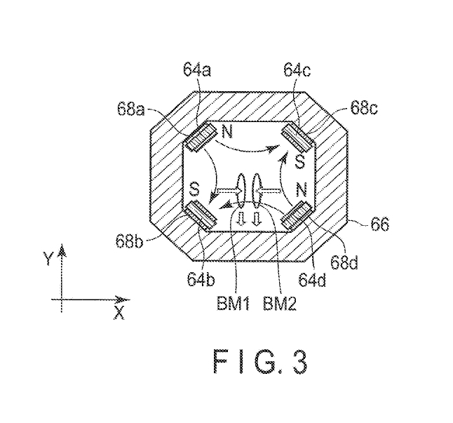

FIG. 3 is a diagram showing the principle of the quadrupole magnetic-field generator of the present embodiment. In FIG. 3, an X direction and a Y direction are directions perpendicular to the direction in which electron beams are emitted, and are orthogonal to each other. Furthermore, the X direction is a direction extending from the magnetic pole 38b (magnetic pole 68a) side toward the magnetic pole 68d (magnetic pole 68c) side, and the Y direction is a direction extending from the magnetic pole 38d (magnetic pole 68b) side toward the magnetic pole 68c (magnetic pole 68a) side.

In FIG. 3, an electron beam BM1 emitted from the filament 361a and an electron beam BM2 emitted from the filament 361b are assumed to travel from a side closer to the reader toward a side farther from the reader in the drawing. The electron beam BM1 and the electron beam BM2 are each assumed to be emitted in a circle. Furthermore, in FIG. 3, the magnetic pole 68a generates an N-pole magnetic field, the magnetic pole 68b generates an S-pole magnetic field, the magnetic pole 68c generates an S-pole magnetic field, and the magnetic pole 68d generates an N-pole magnetic field. In such a case, magnetic fields traveling from the magnetic pole 68a to the magnetic poles 68c and 68d and magnetic fields traveling from the magnetic pole 68d to the magnetic poles 68c and 68b are formed. When assumed to pass through the center of a space surrounded by the magnetic poles 68a to 68d, the electron beam BM1 and the electron beam BM2 are moved (polarized) toward each other in the X direction by a Lorentz force of the generated magnetic fields and moved (polarized) in a given direction. In the present embodiment, the quadrupole magnetic-field generator 60 is installed in such a manner that a central position thereof is eccentric to the central axis of the cathode 36 in the radial direction (or the Y direction) of the anode target 35. Thus, when assumed to pass through the center of the space surrounded by the magnetic poles 68a to 68d, the electron beam BM1 and the electron beam BM2 are significantly subjected to the action of a Lorentz force in opposed directions along the X direction and a Lorentz force applied in one direction along the Y direction.

For example, as shown in FIG. 3, the electron beam BM1 and the electron beam BM2 pass through electron orbits which are symmetric with respect to the central position of the quadrupole magnetic-field generator 60 in the X direction. In this case, the electron beam BM1 and the electron beam BM2 are significantly subjected to the action of Lorentz forces applied toward the center of the quadrupole magnetic-field generator 60 in the X direction and Lorentz forces applied in a direction opposite to the direction toward the center of the quadrupole magnetic-field generator 60 along the Y direction. That is, the quadrupole magnetic-field generator 60 varies a position with respect to electron beams emitted from the cathode 36 to vary the intensity of the action of magnetic fields acting on each of the electron beam BM1 and the electron beam BM2. The electron beam BM1 is significantly subjected to the action of magnetic fields from the magnetic poles 68a and 68b located in proximity to the electron beam BM1 in the X direction, and the electron beam BM2 is significantly subjected to the action of magnetic fields from the magnetic poles 68c and 68d located in proximity to the electron beam BM2 in the X direction. As a result, as shown in FIG. 3, the electron beam BM1 and the electron beam BM2 are polarized in a direction in which the electron beams BM1 and BM2 approach each other, with the lengths of the electron beams BM1 and BM2 not substantially deformed in the Y direction, and the electron beam BM1 and the electron beam BM2 are also polarized in a direction opposite to a direction toward the center of the quadrupole magnetic-field generator 60 in the Y direction. At this time, the electron beam BM1 and the electron beam BM2 form a focus at a position resulting from movement on the electron orbit in the radial direction of the anode target 35 with respect to a focus on the anode target 35 formed when no magnetic field acts (a position displaced on the electron orbit in the radial direction of the anode target 35 with respect to the focus on the anode target 35 formed when no magnetic field acts). The intensity of a current supplied to the quadrupole magnetic-field generator 60 is adjusted to allow the quadrupole magnetic-field generator 60 to synthesize the electron beam BM1 and the electron beam BM2 and to freely vary a width dimension of a focus resulting from the synthesis (the length of the focus of the beams in a direction perpendicular to a length direction of the focus), with the length dimension of the focus (the length of the focus of the beams extending in the radial direction of the anode target 35) maintained.

In the present embodiment, if the X-ray tube device 1 is driven, the filaments 361a and 361b emit the electron beam BM1 and the electron beam BM2 toward the focus on the anode target 35 bombarded by electrons. Here, the filaments 361a and 362b emit electrons (beams) substantially perpendicularly to emission angles α1 and α2 of the converging surfaces 363a and 363b. The plurality of emitted electron beams BM1 and BM2 travel to the anode target 35 in parallel. In the quadrupole magnetic-field generator 60, each of the coils 64 (coils 64a to 64d) is supplied with a direct current from the power source not shown in the drawings. When a direct current is supplied, the quadrupole magnetic-field generator 60 generates magnetic fields among the magnetic poles 68a to 68d, which are a quadrupole. The plurality of electron beams BM1 and BM2 emitted from the cathode 36 passes through magnetic fields generated between the cathode 36 and the anode target 35 and are bombarded on the anode target 35. Since the quadrupole magnetic-field generator 60 is installed in such a manner that the central position thereof is eccentric in the radial direction of the anode target 35, the electron beams BM1 and BM2 are subjected by the action of magnetic fields from the quadrupole magnetic-field generator 60 to Lorentz forces focused on the center in the X direction and Lorentz forces in a direction opposite to a central direction of the quadrupole magnetic-field generator 60 along the Y direction as shown in FIG. 3. At this time, the plurality of electron beams BM1 and BM2 is focused by magnetic fields generated by the quadrupole magnetic-field generator 60 to form one synthetic focus in such a manner that the synthetic focus forms a desired width dimension.

In the present embodiment, the quadrupole magnetic-field generator 60 is installed in such a manner that the central position thereof is eccentric in the radial direction of the anode target 35. Thus, the quadrupole magnetic-field generator 60 makes the beam width of each of the plurality of electron beams thinner than in a case where the action of magnetic fields from the quadrupole magnetic-field generator 60 is not provided, and applies such Lorentz forces as focus the plurality of electron beams BM1 and BM2 into one electron beam. Furthermore, the quadrupole magnetic-field generator 60 can polarize the plurality of electron beams BM1 and BM2 in a predetermined direction. For example, as shown in FIG. 3, the quadrupole magnetic-field generator 60 deform the plurality of electron beams emitted in circles by the Lorentz forces of magnetic fields into elliptic shapes and polarize the electron beams BM1 and BM2 in a direction along the X direction in which the electron beams BM1 and BM2 approach each other. Moreover, the quadrupole magnetic-field generator 60 can polarize each of the plurality of electron beams BM1 and BM2 in the direction opposite to the direction of the center of the anode target 35 along the Y direction (the radial direction of the anode target 35). In this case, the intensity of the magnetic fields may be adjusted so as to correct focus misalignment resulting from an assembly error in each tube or focus misalignment resulting from a variation in tube voltage. Furthermore, the above-described focus misalignment may be regulated by the angles of the emission angles α1 and α2 of the converging surfaces 363a and 363b of the cathode 36, the installation position of the quadrupole magnetic-field generator 60, or the like.

According to the present embodiment, the X-ray tube device 1 is provided with the X-ray tube provided with the cathode 36 having the plurality of filaments and the quadrupole magnetic-field generator 60 configured to focus a plurality of electron beams to form a synthetic focus at a desired position in a desired shape. The quadrupole magnetic-field generator 60 is installed so as to form a synthetic focus at the desired position in the desired shape. Furthermore, the quadrupole magnetic-field generator 60 forms magnetic fields among the magnetic poles 68a to 68d as a result of the supply of a direct current from the power source not shown in the drawings to the coils 64. At this time, in the quadrupole magnetic-field generator 60, the current is regulated so as to form a focus at the desired position in the desired shape. Therefore, the X-ray tube device 1 of the present embodiment enables electron beams to overlap accurately on the anode target. As a result, the X-ray tube device of the present embodiment can obtain an X-ray focus having a higher X-ray radiation intensity than an X-ray tube device having the same size as that in the conventional art and forming a focus using conventional small-focus filaments.

Furthermore, the X-ray tube device 1 of the present embodiment can superimpose the electron beams BM1 and BM2 emitted from each of the plurality of filaments 361a and 361b and deform the beam shape of each of the electron beams BM1 and BM2. Therefore, the X-ray tube device 1 can obtain a synthetic focus having an optimal size and an optimal X-ray radiation intensity according to the purpose of photographing and photographing conditions.

A modification example of the present embodiment will be described below with reference to the drawings.

The X-ray tube device 1 of the modification example has a configuration substantially equivalent to the configuration of the X-ray tube device 1 of the first embodiment. Thus, the same components of the X-ray tube device 1 of the modification example as the corresponding components of the X-ray tube device of the first embodiment are denoted by the same reference numerals, and detailed description of these components is omitted.

### Modification Example 1

The X-ray tube device 1 of a modification example 1 of the first embodiment is provided with an additional filament in addition to the configuration of the first embodiment.

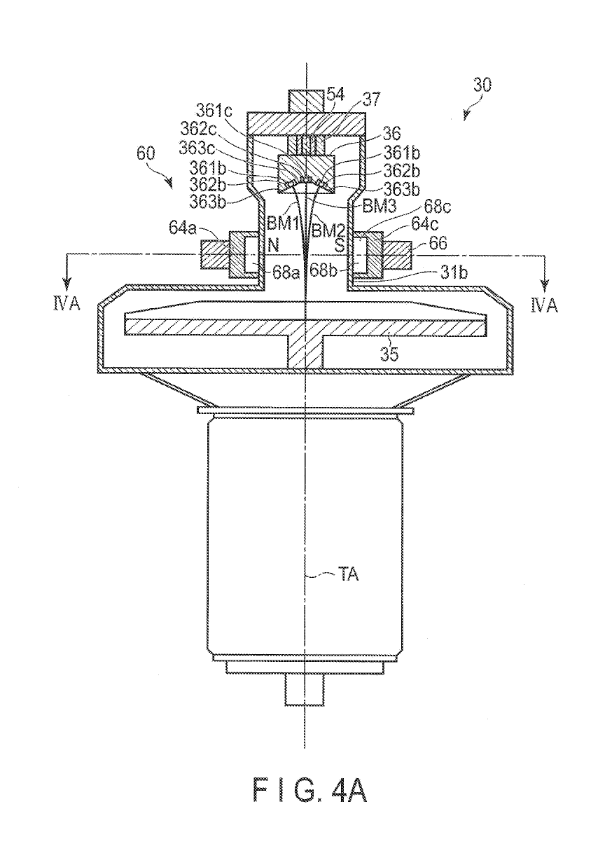

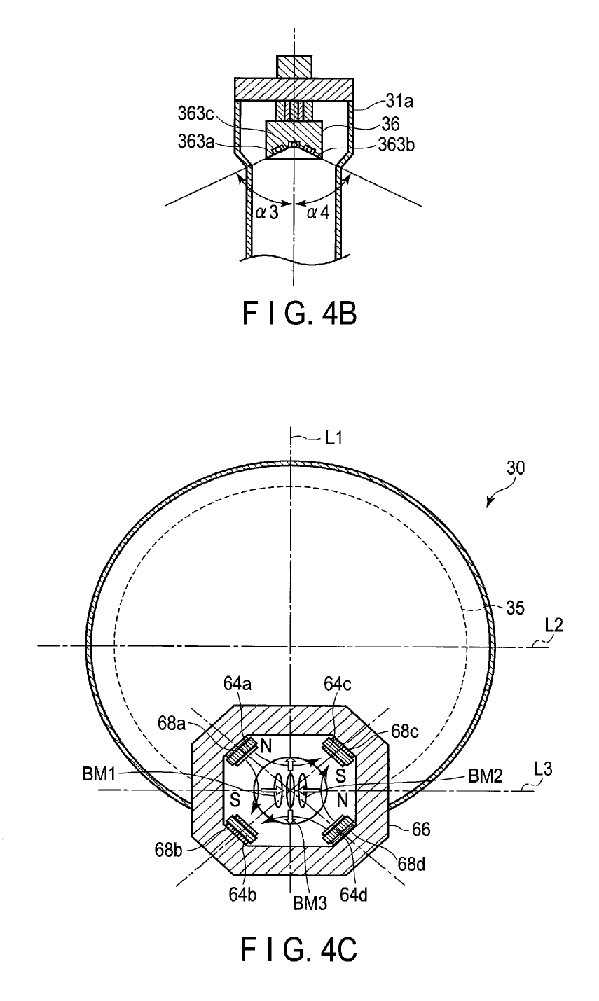

FIG. 4A is a cross-sectional view schematically showing an X-ray tube of the modification example 1 of the first embodiment. FIG. 4B is a diagram of a cathode of the modification example 1 of the first embodiment. FIG. 4C is a cross-sectional view taken along an IVA-IVA line in FIG. 4A.

The cathode of the modification example is provided with a filament 361c, a converging groove 362c, and a converging surface 363c. Here, the filament 361c is provided between the above-described filament 361a and the filament 361b so as to be opposed to the anode target 35. In the present embodiment, the cathode 36 simultaneously emits all electron beams, but filaments that emit electron beams can adjustably be selected from a plurality of installed filaments.

When a negative high voltage is applied to the filament 361c, the filament 361c emits electrons (beams). For example, the filament 361c is a filament for a large focus. Furthermore, each of the filaments 361a and 361b is provided with a converging electrode configured to converge electron beams emitted to surroundings. For example, like the filaments 361a and 361b, the filament 361c is shaped to be thin in a direction perpendicular to the central axis of the cathode 36, for example, shaped like a rectangle.

The converging groove (converging groove portion) 362c is formed by hollowing out a portion of the anode target 35 side of the cathode 36 into a rectangular groove. The converging groove 362c has the converging surface 363c described below and shaped like a recessed portion. The converging groove 362c houses the filament 361c. For example, the focusing groove portion 362c is provided with the filament 361c in the center of the groove and a converging electrode along an inner circumferential portion of the groove.

The converging surface 363c is an end face provided between the converging surface 363a and the converging surface 363b so as to lie parallel and opposite to the anode target 35. In this case, the converging surface 363a and the converging surface 363b are each formed to incline at a predetermined angle from an end of the converging groove 362c to a side portion of the cathode 36. For example, the converging surface 363c has a central axis formed to coincide with the central axis of the cathode 36. In this case, the converging surfaces 363a and 363b are formed to incline symmetrically with respect to the central axis of the cathode 36. The filaments 361a and 361b are provided symmetrically with respect to the central axis of the cathode 36, and the converging grooves (converging groove portions) 362a and 362b are provided symmetrically with respect to the central axis of the cathode 36. The shapes and angles of the converging surfaces 363a, 363b, and 363c are polarized as needed according to distances between each of the filaments 361a, 361b, and 361c and the anode target 35 and the sizes of the filaments 361a, 361b, and 361c. The converging surfaces 363a and 363b are preferably set at as shallow an angle as possible with respect to a flat surface parallel to a surface (tip surface) opposed to the anode target 35 of the cathode 36, for example, the converging surface 363c.

Here, the converging surfaces 363a and 363b with shallow angles indicate that, in FIG. 4A and FIG. 4B, the converging surfaces 363a and 363b are formed at an angle close to parallelism to the converging surface 363c. Furthermore, the converging surfaces 363a and 363b with shallow angles indicate that, in FIG. 4A and FIG. 4B, the angle is close to parallelism to the central axis of the cathode 36 or the orbits of electron beams from the filament 361c.

In FIG. 4B, an emission angle which is an inclination angle from the central axis of the cathode 36 or the orbits of electron beams from the filament 361c, to the converging surface 363c, is denoted as α3, and an emission angle which is an inclination angle from the central axis of the cathode 36 or the orbits of electron beams from the filament 361c, to the converging surface 363b, is denoted as α4. The emission angles α3 and α4 are set so as to allow the focus of a plurality of electron beams to be formed at a desired position with the action of magnetic fields from the quadrupole magnetic-field generator 60 described below taken into account. That is, the converging surfaces 363a and 363b of the cathode 36 are formed at predetermined emission angles α3 and α4 so as to generate a focus at a desired position. For example, the emission angles α3 and α4 are formed in such a manner that 45°<α3<90° and 45°<α4<90°. The emission angles α3 and α4 are formed in such a manner that 50°<α3<70° and 50°<α4<70°. Such setting of the emission angles α3 and α4 is known to allow a plurality of electron beams to overlap without being enlarged.

If a filament for a large focus and two filaments for a small focus are provided, it is important that the filament for a large focus and the corresponding converging electrode be provided in a central portion of the cathode main body of the cathode and at a deep position in a depth direction of the most recessed portion. That is, experiments confirm that, if not provided between the above-described filament for a large focus and each of the above-described filaments for a small focus, electron (thermal electron) beams radiated from the two filaments for a small focus fail to overlap reliably at the focal position on the anode target under the effect of electric fields from the converging electrode covering the periphery of the filament for a large focus and the remaining converging electrode (which covers the filaments for a small focus).

The quadrupole magnetic-field generator 60 is installed in such a manner that the small diameter portion 31b is surrounded by an inner circumferential portion of the yoke 66 described below. In the present embodiment, the quadrupole magnetic-field generator 60 is installed substantially coaxially with the central axis of the cathode 36.

According to the modification example 1 of the present embodiment, the X-ray tube device 1 is provided with the three filaments so that the filament which emits electron beams can be optionally selected. Therefore, in the X-ray tube device 1 of the modification example 1, electron beams emitted from at least two filaments are regulated by the quadrupole magnetic-field generator 60 to allow formation of a focus which has a size larger than the size in the case of the cathode 36 of the first embodiment and which provides a high loading capability. Furthermore, the X-ray tube device 1 is provided with the three filaments but may be provided with at least two filaments.

The quadrupole magnetic-field generator 60 of the modification example 1 is installed coaxially with the central axis of the cathode, but may be eccentrically installed in such a manner that the center of the quadrupole magnetic-field generator 60 does not overlap the central axis of the cathode.

Now, an X-ray tube device according to another embodiment will be described. The same components of the another embodiment as the corresponding components of the above-described first embodiment are denoted by the same reference numerals, and detailed description of these components is omitted.

### Second Embodiment

The X-ray tube device 1 of a second embodiment is further provided with a coil configured to polarize electron beams in addition to the configuration of the first embodiment.

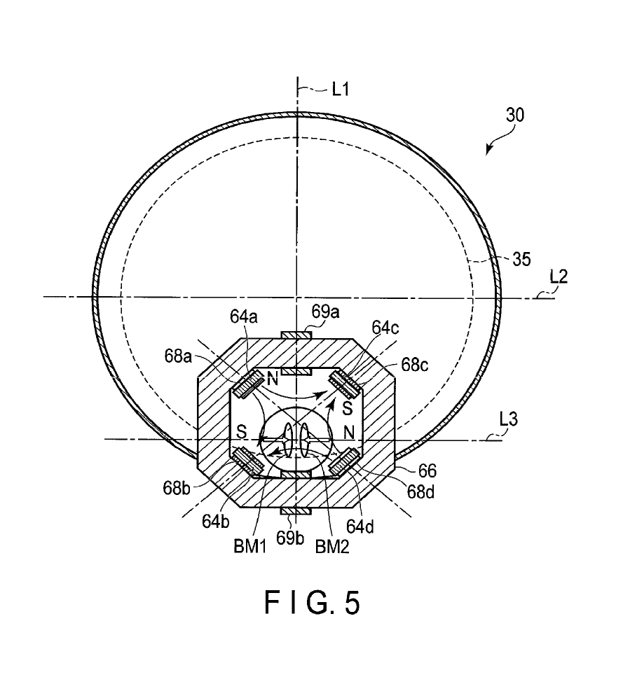

FIG. 5 is a diagram schematically showing the X-ray tube device of the second embodiment.

As shown in FIG. 5, the quadrupole magnetic-field generator 60 of the second embodiment is further provided with polarizing coil portions 69a, 69b.

The quadrupole magnetic-field generator 60 generates superimposed dipole DC magnetic fields in such a manner that magnetic fields generated from two pairs of magnetic poles act in the same direction. The quadrupole magnetic-field generator 60 is provided with a pair of magnetic poles 68a and 68c and a pair of magnetic poles 68b and 68d. The magnetic pole pair 68a, 68c and the magnetic pole pair 68b, 68d each act as a dipole to form magnetic fields. In the quadrupole magnetic-field generator 60, each of the polarizing coil portions 69a, 69b described below are supplied with a current to form a magnetic field by superimposing a DC magnetic field on a DC magnetic field generated between the magnetic pole pair 68a, 68c and the magnetic pole pair 68b, 68d.

In the quadrupole magnetic-field generator 60, a DC current supplied to each of the polarizing coil portions 69a, 69b described below by the power source (not shown in the drawings) is controlled by a polarizing power source control portion (not shown in the drawings). By installing the quadrupole magnetic-field generator 60 in such a manner that the center thereof is perpendicularly eccentric to the central axis of the cathode 36, electron beams in a desired direction can be deformed and polarized. For example, as shown in FIG. 5, the quadrupole magnetic-field generator 60 can deform electron beams emitted from the cathode 36 so as to reduce the width of each electron beam and can correct, by polarization, movement in the radial direction associated with the deformation of the width. That is, the quadrupole magnetic-field generator 60 can adjust the position of the focus on the surface of the anode target 35 bombarded by electron beams and reduce a thermal load on the focus.

The polarizing coil portions 69a, 69b (a first polarizing coil portion, a second polarizing coil portion) are electromagnetic coils to which a current is supplied by the power source (not shown in the drawings) and which generate magnetic fields. In the present embodiment, the polarizing coil portions 69a, 69b are supplied with a direct current from the power source (not shown in the drawings) to generate DC magnetic fields. Currents supplied to the polarizing coil portions 69a, 69b allow the polarizing coil portions 69a, 69b to polarize the orbits of electron beams in a predetermined direction. Each of the polarizing coil portions 69a, 69b are wound between any two of the magnetic poles 68a to 68d connected to the yoke 66. As shown in FIG. 4, the polarizing coil portion 69a is wound around the main body portion of the yoke 66 between the magnetic poles 68a and 68c. The polarizing coil portion 69b is wound around the main body portion of the yoke 66 between the magnetic poles 68b and 68d. In this case, the magnetic pole pair 68a, 68c generates a DC magnetic field between the magnetic poles 68a and 68c, and the magnetic pole pair 68b, 68d generates a DC magnetic field between the magnetic poles 68b and 68d.

The principle of the quadrupole magnetic-field generator 60 of the present embodiment will be described below with reference to the drawings.

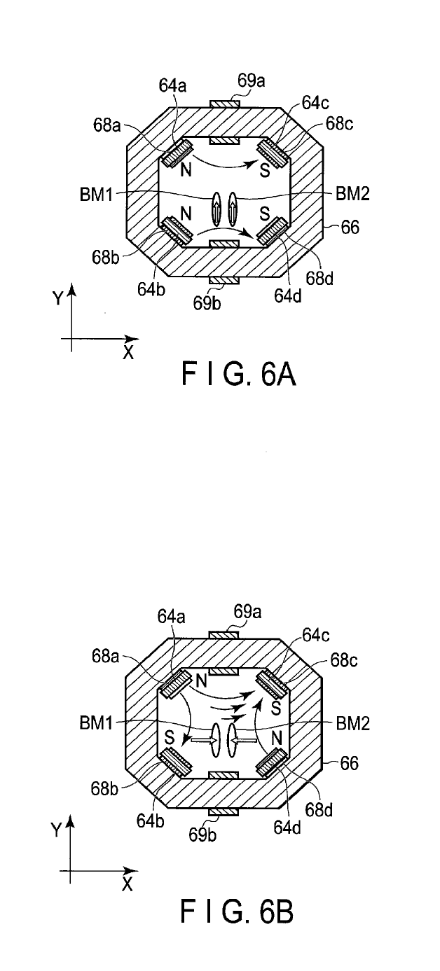

FIG. 6A is a diagram showing the principle of dipole magnetic fields of the second embodiment, and FIG. 6B is a diagram showing the principle of the quadrupole magnetic-field generator 60 of the second embodiment. In FIG. 6A and FIG. 6B, the X direction and the Y direction are directions perpendicular to the direction in which electron beams are emitted, and are orthogonal to each other. Furthermore, the X direction is a direction extending from the magnetic pole 68b (magnetic pole 68a) side toward the magnetic poles 68d (magnetic pole 68c) side, and the Y direction is a direction extending from the magnetic pole 68d (magnetic pole 68b) side toward the magnetic poles 68c (magnetic pole 68a) side.

In FIG. 6A and FIG. 6B, the electron beam BM1 emitted from the filament 361a and the electron beam BM are assumed to travel from the side closer to the reader toward the side farther from the reader in the drawing. Furthermore, in FIG. 6A and FIG. 6B, the magnetic poles 68a and 68c are a dipole forming a pair (magnetic pole pair), and the magnetic poles 68b and 68d are a dipole forming a pair (magnetic pole pair). The magnetic pole pair 68a, 68c generates a DC magnetic field traveling in a direction following the X direction, and the magnetic pole pair 68b, 68d generates a DC magnetic field following the X direction. Here, if not subjected to the action of the polarizing coil portions 69a, 69b, the quadrupole magnetic-field generator 60 generates magnetic fields as shown in FIG. 3 for the first embodiment.

As shown in FIG. 6A, the polarizing coil portion 69a generates an N-pole magnetic field at the magnetic pole 68a and generates an S-pole magnetic field at the magnetic pole 68c. Similarly, the polarizing coil portion 69b generates an N-pole magnetic field at the magnetic pole 68b and generates an S-pole magnetic field at the magnetic pole 68d. Therefore, the magnetic field traveling from the magnetic pole 68a toward the magnetic pole 68c and the magnetic field traveling from the magnetic pole 68b toward the magnetic pole 68d are formed by the polarizing coil portion 69a and the polarizing coil portion 69b, respectively.

The quadrupole magnetic-field generator 60 is subjected to the action of magnetic fields from the polarizing coil portions 69a, 69b as shown in FIG. 6A to superimpose a magnetic field generated by the polarizing coil portion 69a on a magnetic field traveling from the magnetic pole 68a toward the magnetic pole 68c, while superimposing a magnetic field generated by the polarizing coil portion 69b on a magnetic field traveling from the magnetic pole 68d toward the magnetic pole 68b. Therefore, as shown in FIG. 6B, the quadrupole magnetic-field generator 60 generates superimposed magnetic fields traveling from the magnetic pole 68a toward the magnetic pole 68c in addition to magnetic fields from the quadrupole. Here, the magnetic fields between the magnetic poles 68b and the magnetic pole 68d cancel each other.

In the present embodiment, when the X-ray tube device 1 is driven, the filament 361a and filament 361c of the cathode 36 emit electrons toward electrons on the anode target 35. In the quadrupole magnetic-field generator 60, the polarizing coil portions 69a, 69b are supplied with a direct current from the power source not shown in the drawings. For example, when a direct current from the power source is supplied to the quadrupole magnetic-field generator 60, the quadrupole magnetic-field generator 60 forms a magnetic field by superimposing magnetic fields generated by the polarizing coil portions 69a, 69b on magnetic fields from the quadrupole between the magnetic pole pair 68a, 68c, which is a dipole, and the magnetic pole pair 68b, 68d, which is a dipole. Therefore, for example, as shown in FIG. 6B, when arranged perpendicularly eccentrically to the central axis of the cathode 36, the quadrupole magnetic-field generator 60 can correct, by polarization, movement (misalignment, eccentricity) of electron beams in the length direction (Y direction) thereof resulting from deformation of the electron beams in the width direction (X direction) by magnetic fields from the quadrupole.

According to the present embodiment, the X-ray tube device 1 is provided with the quadrupole magnetic-field generator 60 provided with the polarizing coil portions 69a, 69b. When the polarizing coil portions 69a and 69b are supplied with a direct current from the power source, the quadrupole magnetic-field generator 60 can generate superimposed magnetic fields. The quadrupole magnetic-field generator 60 of the first embodiment is installed in misalignment with (eccentrically to) the orbits of a plurality of electron beams to achieve polarization in one direction. However, the quadrupole magnetic-field generator 60 of the present embodiment can correct, by polarization, movement (misalignment, eccentricity) of electron beams in the length direction thereof (Y direction) resulting from deformation of the electron beams in the width (X direction). Therefore, the X-ray tube device 1 of the present embodiment can magnetically change the shape of a plurality of electron beams into an optimal shape according to an intended use and focus the plurality of electron beams.

In the present embodiment, in the quadrupole magnetic-field generator 60, the polarizing coil portions 69a, 69b are supplied with a direct current from the power source but may be supplied with an alternating current.

In such a case, the quadrupole magnetic-field generator 60 generates dipole AC magnetic fields in such a manner that magnetic fields generated from two pairs of magnetic poles act in the same direction. For example, the quadrupole magnetic-field generator 60 is provided with a pair of the magnetic pole 68a and the magnetic pole 68c and a pair of the magnetic pole 68b and the magnetic pole 68c. The magnetic pole pair 68a, 68c and the magnetic pole pair 68b, 68d each act as a dipole to form magnetic fields. The magnetic pole pair 68a, 68c and the magnetic pole pair 68b, 68d each form an AC magnetic field between the magnetic poles.

The quadrupole magnetic-field generator 60 can intermittently or continuously polarize the orbits of electrons based on an AC magnetic field generated between the poles of the dipole as a result of supply of an alternating current. In the quadrupole magnetic-field generator 60, an alternating current from the power source (not shown in the drawings) supplied to each of the polarizing coil portions 69a, 69b described below is controlled by the polarizing power source control unit (not shown in the drawings) so as to intermittently or continuously move the focus bombarded by a plurality of electron beams emitted from the plurality of filaments from the cathode 36. The quadrupole magnetic-field generator 60 can polarize electron beams emitted from the cathode 36 in a direction along the radial direction of the anode target 35. That is, the quadrupole magnetic-field generator 60 can move the position of the focus on the surface of the anode target 35 resulting from focusing of a plurality of electron beams.

A modification example of the present embodiment will be described below with reference to the drawings. The X-ray tube device 1 of the modification example has a configuration substantially equivalent to the configuration of the X-ray tube device 1 of the above-described embodiment. Thus, the same components of the X-ray tube device 1 of the modification example as the corresponding components of the X-ray tube device of the above-described embodiment are denoted by the same reference numerals, and detailed description of these components is omitted.

### Modification Example 2

The X-ray tube device 1 of a modification example 2 of the second embodiment is provided with a quadrupole magnetic-field generator 601 provided with polarizing coil portions 69c1 and 69d1 and a quadrupole magnetic-field generator 602 provided with the above-described polarizing coil portions 69a2 and 69b2.

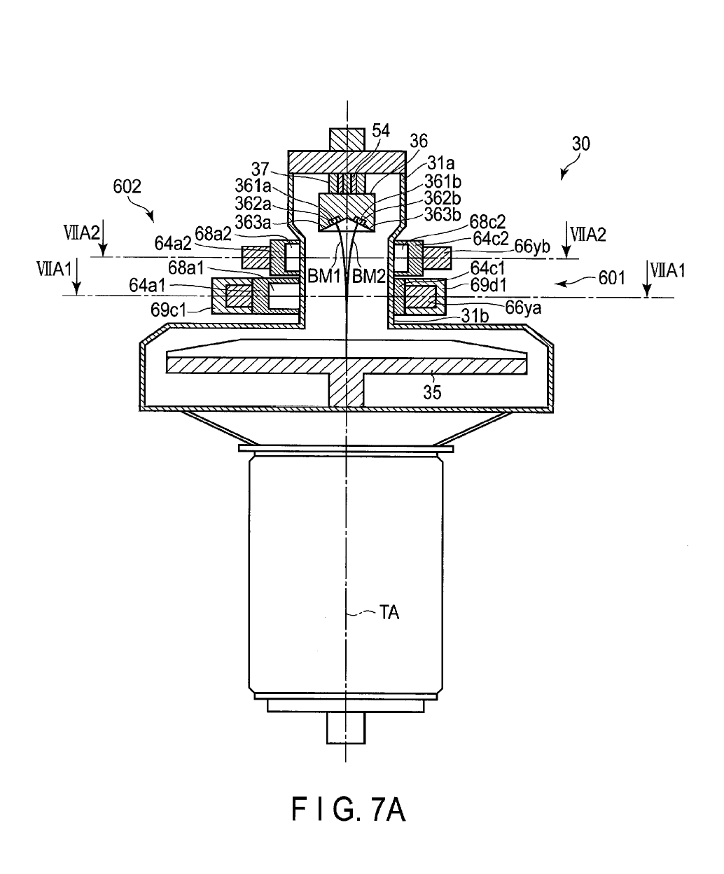

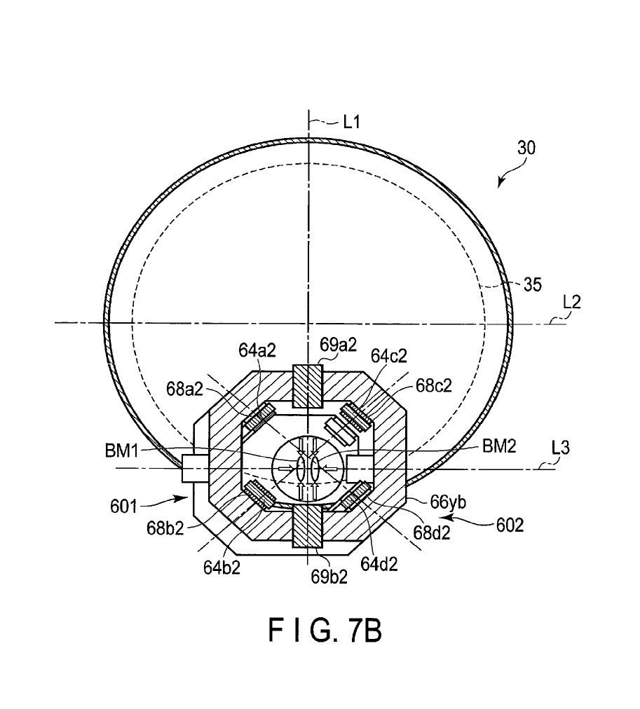

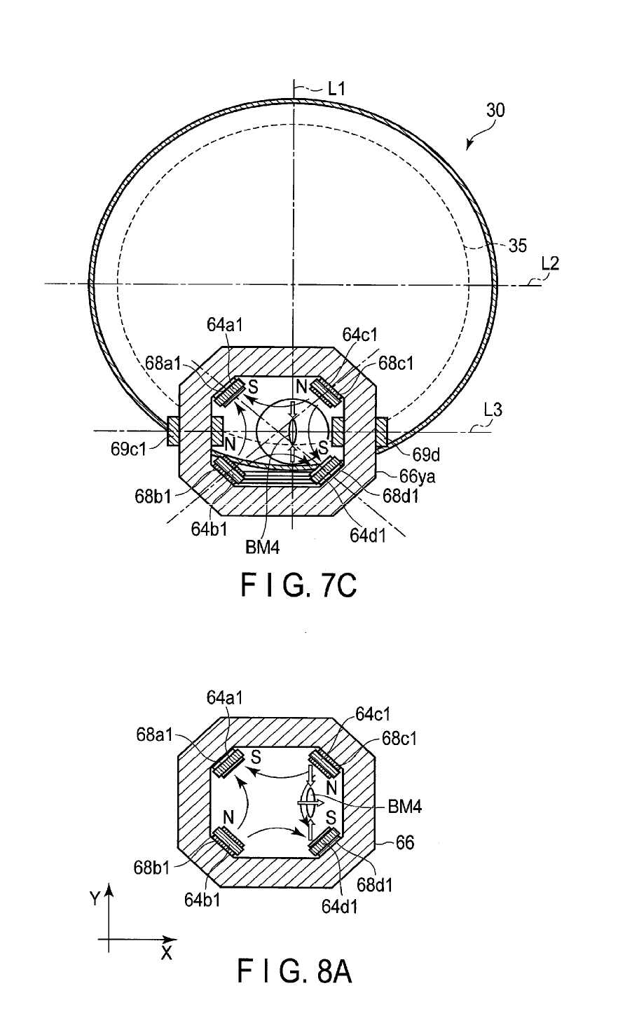

FIG. 7A is a cross-sectional view schematically showing the X-ray tube 30 of the modification example 2 of the second embodiment. FIG. 7B is a cross-sectional view taken along a VIIA2-VIIA2 line in FIG. 7A, and FIG. 7C is a cross-sectional view taken along a VIIA1-VIIA1 line in FIG. 7A.

As shown in FIG. 7A, the X-ray tube 30 of the modification example 2 of the present embodiment is provided with the two quadrupole magnetic-field generators 601 and 602.

As shown in FIG. 7A and FIG. 7C, the quadrupole magnetic-field generator 601 is provided with the polarizing coil portion 69c1 and the polarizing coil portion 69d1.

Each of the polarizing coil portions 69c1, 69d1 is supplied with a current from the power source (not shown in the drawings) to generate a magnetic field. In the present embodiment, each of the polarizing coil portions 69c1, 69d1 is supplied with a direct current from the power source (not shown in the drawings) to generate a DC magnetic field. The polarizing coil portions 69c1, 69d1 can polarize the orbits of electron beams in a predetermined direction by varying a current ratio of supplied currents. Each of the polarizing coil portions 69c1, 69d1 is wound between any two of the magnetic poles 68a to 68d connected to the yoke 66. As shown in FIG. 6B, the polarizing coil portion 69c1 is wound around the main body portion of the yoke 66 between the magnetic poles 68a1 and 68b1. The polarizing coil portion 69d1 is wound around the main body portion of the yoke 66 between the magnetic poles 68c1 and 68d1. In this case, for example, the magnetic pole pair 68a, 68b generates a DC magnetic field between the magnetic poles, and the magnetic pole pair 68c, 68d generates a DC magnetic field between the magnetic poles.

The quadrupole magnetic-field generators 601 and 602 are each provided on the small diameter portion 31b. That is, the quadrupole magnetic-field generators 601 and 602 are arranged on the small diameter portion 31b. The quadrupole magnetic-field generator 601 is installed on the small diameter portion 31b on the anode target 35 side, and the quadrupole magnetic-field generator 602 is installed on the small diameter portion 31b on the cathode side with respect to the quadrupole magnetic-field generator 601.

Furthermore, the quadrupole magnetic-field generators 601 and 602 are each installed perpendicularly eccentrically to the electron orbits of the electron beams emitted from the cathode 36. For example, as shown in FIG. 7C, the quadrupole magnetic-field generator 601 is installed eccentrically in a direction along the straight line L3, and as shown in FIG. 7B, the quadrupole magnetic-field generator 602 is installed eccentrically in a direction along the straight line L1 (in the radial direction of the anode target 35) as is the case with the second embodiment.

The quadrupole magnetic-field generator 601 is provided with coils 64 (64a1, 64b1, 64c1, and 64d1), a yoke 66ya, and magnetic poles 68 (68a1, 68b1, 68c1, and 68d1).

The quadrupole magnetic-field generator 602 has a configuration substantially equivalent to the configuration of the quadrupole magnetic-field generator 60 of the second embodiment. The quadrupole magnetic-field generator 602 is provided with coils 64 (64a2, 64b2, 64c2, and 64d2), a yoke 66yb, and magnetic poles 68 (68a2, 68b2, 68c2, and 68d2).

The coils 64 (64a2, 64b2, 64c2, and 64d2) are substantially equivalent to the coils 64 (64a, 64b, 64c, and 64d) of the second embodiment.

The yokes 66ya and 66yb are substantially equivalent to the yoke 66 of the second embodiment.

The magnetic poles 68 (68a2, 68b2, 68c2, and 68d2) are substantially equivalent to the magnetic poles 68 (68a, 68b, 68c, and 68d) of the second embodiment.

In the present embodiment, as shown in FIG. 7B, the quadrupole magnetic-field generator 602 applies, to a plurality of electron beams, the action of magnetic fields substantially equivalent to the action of magnetic fields in the quadrupole magnetic-field generator 60 of the second embodiment.

As shown in FIG. 7C, the quadrupole magnetic-field generator 601 deforms and polarizes an electron beam BM4 focused and deformed by magnetic fields from the quadrupole magnetic-field generator 602.

The principle of the quadrupole magnetic-field generator 601 of the modification example 2 of the present embodiment will be described below with reference to the drawings.

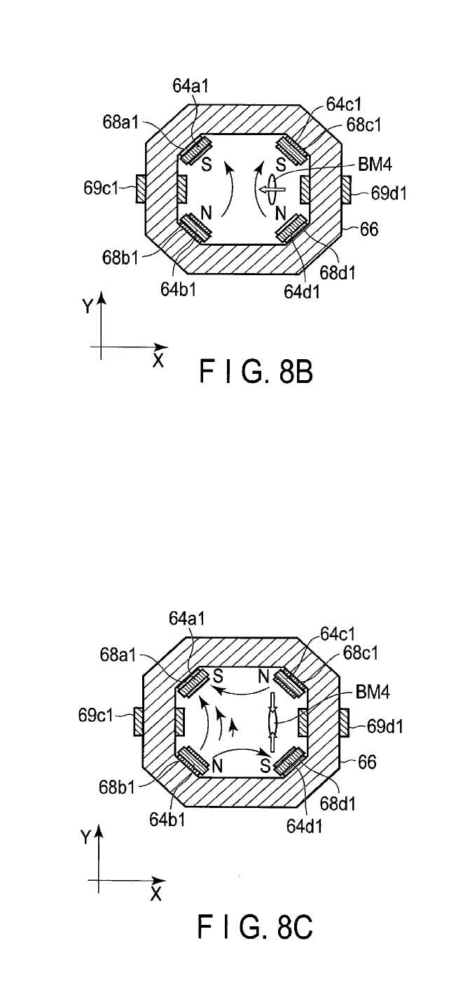

FIG. 8A is a cross-sectional view showing the principle of quadrupole magnetic fields of the modification example 2 of the second embodiment, FIG. 8B is a cross-sectional view showing the principle of dipole magnetic fields of the modification example 2 of the second embodiment, and FIG. 8C is a cross-sectional view showing the principle of a quadrupole magnetic-field generator of the modification example 2 of the second embodiment. In FIG. 8A to FIG. 8C, the X direction and the Y direction are directions perpendicular to the central axis of the cathode 36, and are orthogonal to each other. Furthermore, the X direction is a direction extending from the magnetic pole 68b1 (magnetic pole 68a1) side toward the magnetic pole 68d1 (magnetic pole 68c1) side, and the Y direction is a direction extending from the magnetic pole 68a1 (magnetic pole 68c1) side toward the magnetic pole 68b1 (magnetic pole 68d1) side.

In FIG. 8A to FIG. 8C, the electron beam BM4, into which the electron beam BM1 and the electron beam BM2 are aggregated by the quadrupole magnetic-field generator 60, is assumed to travel from the side closer to the reader toward the side farther from the reader in the drawing. Furthermore, in FIG. 8A to FIG. 8C, the magnetic pole 68a1 and the magnetic pole 68b1 are a dipole forming a pair (magnetic pole pair), and the magnetic pole 68c1 and the magnetic pole 68d1 are a dipole forming a pair (magnetic pole pair). The magnetic pole pair 68a1, 68b1 generates a DC magnetic field traveling in a direction following the Y direction, and the magnetic pole pair 68c1, 68d1 generates a DC magnetic field traveling in a direction following the Y direction.

As shown in FIG. 8A, in the modification example 2, if not subjected to the action of the polarizing coil portions 69c1, 69d1, the quadrupole magnetic-field generator 60 generates quadrupole magnetic fields.

As shown in FIG. 8B, the polarizing coil portion 69c1 generates an N-pole magnetic field at the magnetic pole 68a1 and generates an S-pole magnetic field at the magnetic pole 68b1. Similarly, the polarizing coil portion 69d1 generates an N-pole magnetic field at the magnetic pole 68c1 and generates an S-pole magnetic field at the magnetic pole 68d1. Therefore, a magnetic field traveling from the magnetic pole 68a1 toward the magnetic pole 68b1 and a magnetic field traveling from the magnetic pole 68c1 toward the magnetic pole 68d1 are formed by the polarizing coil portion 69c1 and the polarizing coil portion 69d1, respectively.

The quadrupole magnetic-field generator 601 is subjected to the action of magnetic fields from the polarizing coil portions 69c1, 69d1 as shown in FIG. 8B to superimpose a magnetic field generated by the polarizing coil portion 69c1 on a magnetic field traveling from the magnetic pole 68a1 toward the magnetic pole 68b1, while superimposing a magnetic field generated by the polarizing coil portion 69d1 on a magnetic field traveling from the magnetic pole 68c1 toward the magnetic pole 68d1. Therefore, as shown in FIG. 8C, the quadrupole magnetic-field generator 60 generates superimposed magnetic fields traveling from the magnetic pole 68a1 toward the magnetic pole 68b1 in addition to magnetic fields from the quadrupole as shown in FIG. 8A. Here, the magnetic fields between the magnetic poles 68c1 and the magnetic pole 68d1 cancel each other.

In the present embodiment, when the X-ray tube device 1 is driven, the filament 361a and the filament 361b, included in the cathode 36, emit the electron beams BM1 and BM2, respectively, toward the focus of electrons on the anode target 35. The electron beams BM1 and BM2 are assumed to travel along a straight line passing through the center of the cathode 36. In the quadrupole magnetic-field generator 602, each of the polarizing coil portions 69a2, 69b2 is supplied with a direct current from the power source not shown in the drawings. For example, when a direct current from the power source is supplied to the quadrupole magnetic-field generator 602, the quadrupole magnetic-field generator 602 forms a magnetic field by superimposing magnetic fields generated by the polarizing coil portions 69a, 69b on magnetic fields from the quadrupole between the magnetic pole pair 68a, 68c, which is a dipole, and the magnetic pole pair 68b, 68d, which is a dipole. Upon traversing magnetic fields generated by the quadrupole magnetic-field generator 602, a plurality of electron beams BM is focused into the electron beam BM4.

In the quadrupole magnetic-field generator 601, each of the polarizing coil portions 69c1, 69d1 is supplied with a direct current from the power source not shown in the drawings. For example, when a direct current from the power source is supplied to the quadrupole magnetic-field generator 602, the quadrupole magnetic-field generator 602 forms a magnetic field by superimposing magnetic fields generated by the polarizing coil portions 69c1, 69d1 on magnetic fields from the quadrupole of the magnetic poles 68a1 to 68d1. Therefore, as shown in FIG. 8C, when the electron beam BM4 traverses magnetic fields, the quadrupole magnetic-field generator 601 can reduce the length dimension of the electron beam BM4 (the length of the electron beam BM4 in the Y direction) focused by having the width dimension thereof (the length of the electron beam BM4 in the X direction) reduced by the quadrupole magnetic-field generator 602. In this case, for example, for each of the quadrupole magnetic-field generators 601 and 602, an installation position, a voltage intensity, a current direction, and the like are regulated to form electron beams of a desired size or a desired shape of the focus of the electron beams.

According to the present embodiment, the X-ray tube device 1 is provided with the quadrupole magnetic-field generator 601 provided with the polarizing coil portions 69a1, 69b1 and the quadrupole magnetic-field generator 602 provided with the polarizing coil portions 69c2, 69d2. In each of the quadrupole magnetic-field generators 601 and 602, the polarizing coil portions 69a1, 69b1, 69c2, and 69d2 are supplied with a direct current to enable superimposed magnetic fields to be generated. For each of the quadrupole magnetic-field generators 601 and 602 of the modification example 2, the installation position, the voltage intensity, the current direction, and the like are regulated to form electron beams of a desired size or a desired shape of the focus of the electron beams. Therefore, the X-ray tube device 1 of the modification example 2 can magnetically change the shape of a plurality of electron beams into an optimal shape according to an intended use.

In the modification example 2, each of the quadrupole magnetic-field generators 601 and 602 is provided with two polarizing coil portions but may be provided with a further polarizing coil portion. Furthermore, the quadrupole magnetic-field generators 601 and 602 may be installed at opposite positions.

In the modification example 2 of the present embodiment, in the quadrupole magnetic-field generators 601 and 602, the polarizing coil portions 69a1, 69b1, 69c2, and 69d2 may each be supplied with a direct current from the power source but may be supplied with an alternating current.

In such a case, the quadrupole magnetic-field generator 601 generates dipole AC magnetic fields in such a manner that magnetic fields generated from two pairs of magnetic poles act in the same direction. For example, the quadrupole magnetic-field generator 601 is provided with a pair of the magnetic pole 68a1 and the magnetic pole 68b1 and a pair of the magnetic pole 68c1 and the magnetic pole 68d1. The magnetic pole pair 68a1, 68b1 and the magnetic pole pair 68c1, 68d1 each serve as a dipole to form a magnetic field. The magnetic pole pair 68a1, 68b1 and the magnetic pole pair 68c1, 68d1 each form an AC magnetic field between the magnetic poles.

Similarly, the quadrupole magnetic-field generator 602 generates dipole magnetic fields in such a manner that magnetic fields generated from the two pairs of magnetic poles act in the same direction. For example, the quadrupole magnetic-field generator 602 is provided with a pair of the magnetic pole 68a2 and the magnetic pole 68c2 and a pair of the magnetic pole 68b2 and the magnetic pole 68d2. The magnetic pole pair 68a2, 68c2 and the magnetic pole pair 68b2, 68d2 each serve as a dipole to form a magnetic field. The magnetic pole pair 68a2, 68c2 and the magnetic pole pair 68b2, 68d2 each form an AC magnetic field between the magnetic poles.

The quadrupole magnetic-field generators 601 and 602 can each intermittently or continuously polarize the orbits of electrons based on an AC magnetic field generated between the poles of the dipole as a result of supply of an alternating current. In the quadrupole magnetic-field generators 601 and 602, an alternating current from the power source (not shown in the drawings) supplied to each of the polarizing coil portions 69a2, 69b2, 69c1, and 69d1 described below is controlled by the polarizing power source control unit (not shown in the drawings) so as to intermittently or continuously move the focus bombarded by electron beams emitted from the cathode 36. The quadrupole magnetic-field generators 601 and 602 can perform polarization in a desired direction by controlling a current or the like. That is, when each of the quadrupole magnetic-field generators 601 and 602 is supplied with an alternating current, the X-ray tube device 1 can move the position of the focus on the surface of the anode target 35 bombarded by electron beams.

Now, an X-ray tube device according to a third embodiment will be described. The same components of the third embodiment as the corresponding components of the above-described embodiment are denoted by the same reference numerals, and detailed description of these components is omitted.

### Third Embodiment

An X-ray tube device 10 of a third embodiment is different from the X-ray tube devices of the above-described embodiments in that, due to the lack of the housing portion 31a, the anode target 35 and the cathode 36 are installed closer to each other. Thus, the X-ray tube device 10 of the third embodiment is different from the X-ray tube devices of the above-described embodiments in the configurations of the vacuum envelope 31 (vacuum container 32) and the quadrupole magnetic-field generator, and the like.

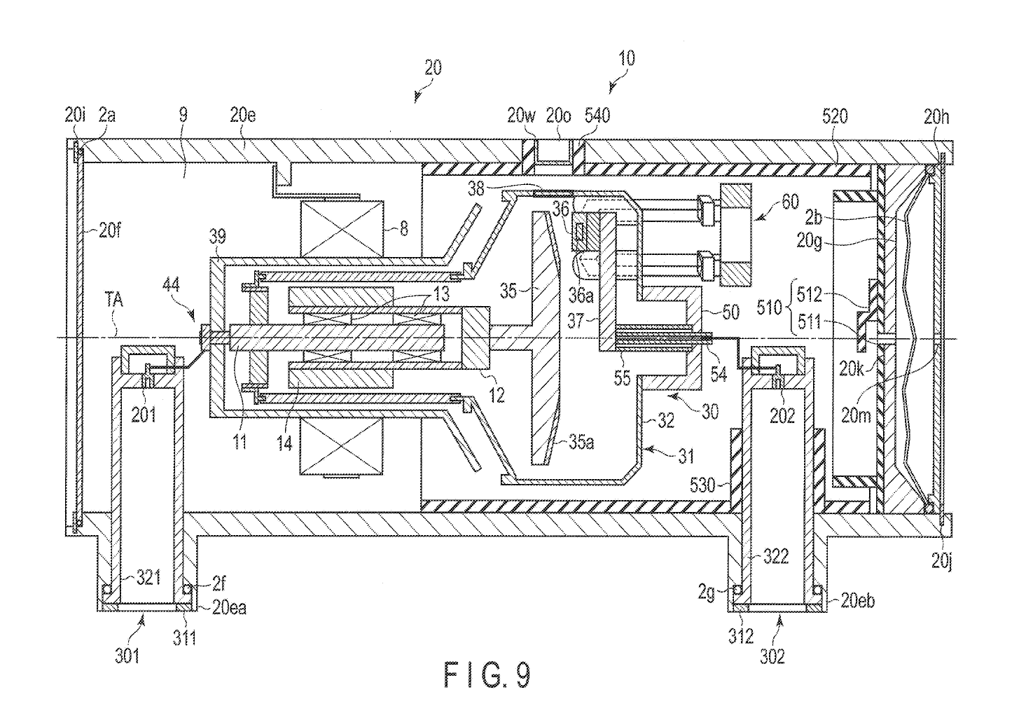

FIG. 9 is a cross-sectional view showing an example of the X-ray tube device of the third embodiment.

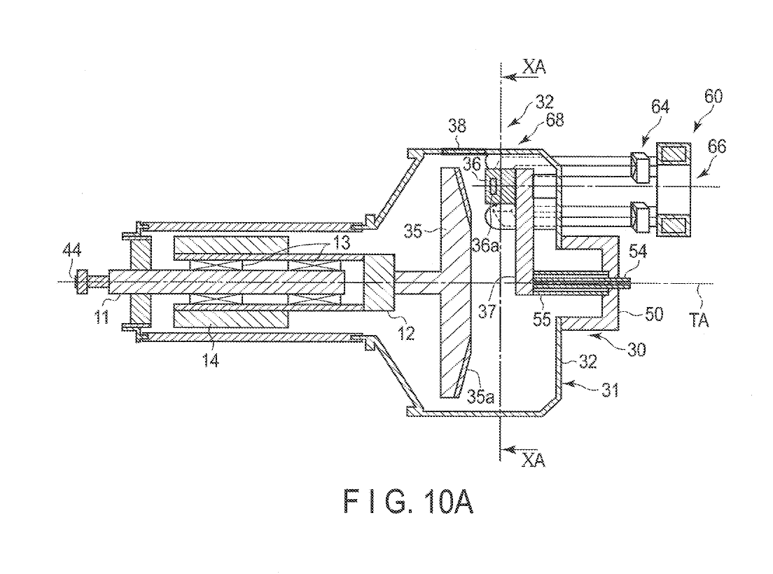

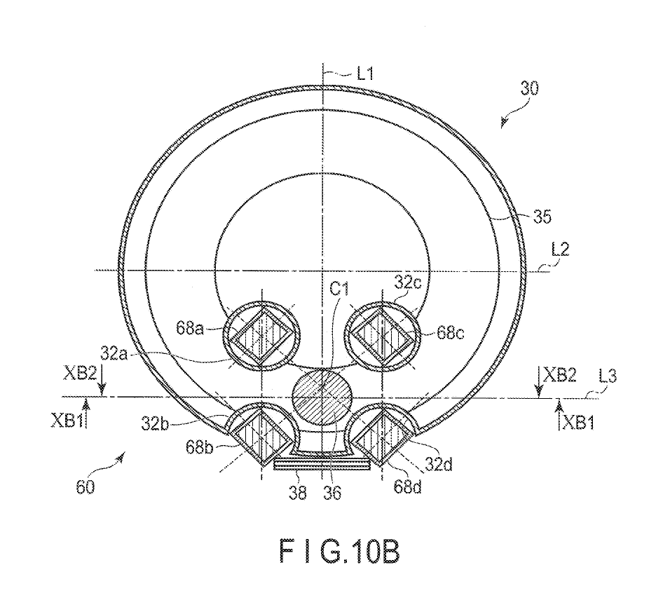

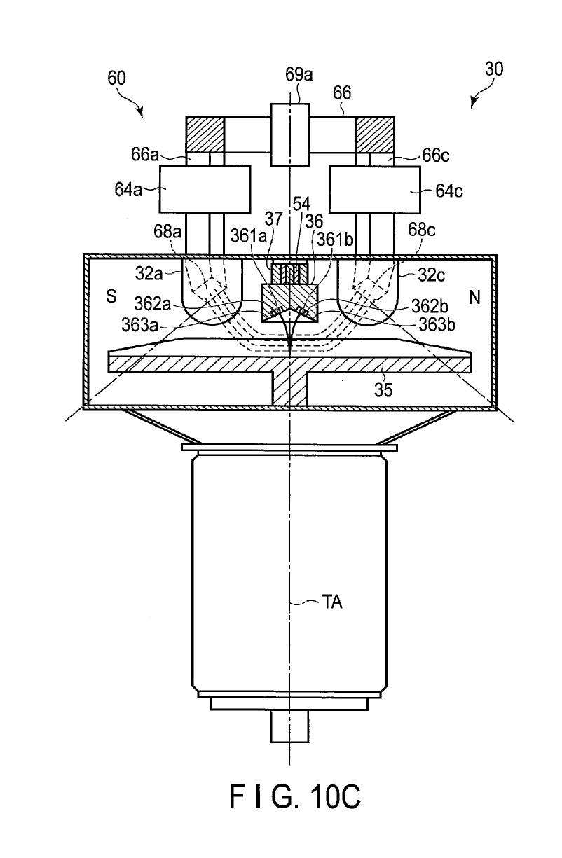

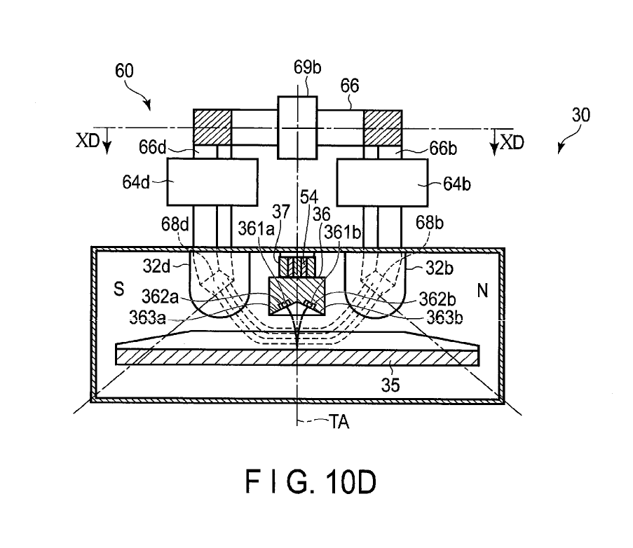

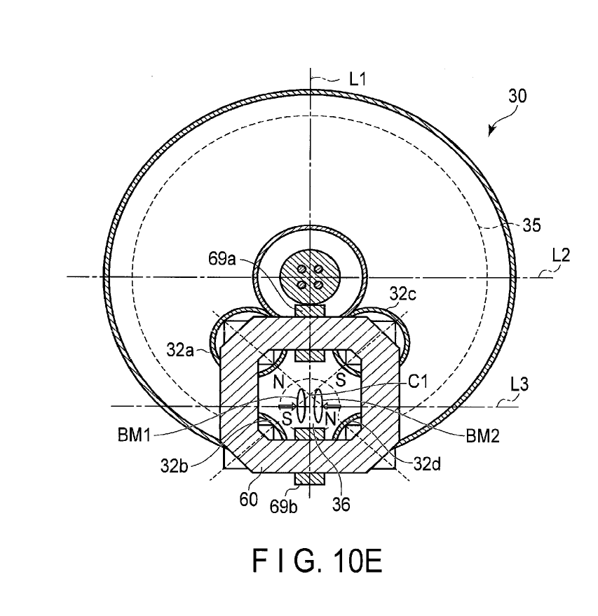

FIG. 10A is a cross-sectional view schematically showing the X-ray tube 30 of the third embodiment, FIG. 10B is a cross-sectional view taken along an XIA-XIA line in FIG. 10A, FIG. 10C is a cross-sectional view taken along an XB1-XB1 line in FIG. 10B, FIG. 10D is a cross-sectional view taken along an XB2-XB2 line in FIG. 10B, and FIG. 10E is a cross-sectional view taken along an XD-XD line in FIG. 10D.

In FIG. 10B and FIG. 10E, a straight line which is orthogonal to the tube axis TA is designated as the straight line L1, and a straight line which is orthogonal to the tube axis TA and the straight line L1 is designated as the straight line L2. In FIG. 10B and FIG. 10E, a straight line which is orthogonal to the center of the cathode 36 or a straight line along the emission direction of electron beams and which is parallel to the straight line L2 is designated as the straight line L3.

The X-ray tube 30 is provided with a KOV member 55 in addition to the configurations of the above-described embodiments.

The anode target 35 is formed of a member which is a nonmagnetic substance and has a high electric conductivity (electric conduction property). For example, the anode target 35 is formed of copper, tungsten, molybdenum, niobium, tantalum, nonmagnetic stainless steel, or the like. The anode target 35 may be configured in such a manner that at least a surface portion thereof is formed of a metal member which is a nonmagnetic substance and which has a high electric conductivity. Alternatively, the anode target 35 may be configured in such a manner that the surface portion thereof is coated with a coating member formed of a metal member which is a nonmagnetic substance and which has a high electric conductivity.

The cathode 36 is attached to the cathode support portion (cathode support body, cathode support member) 37 described below and connected to the high-voltage supply terminal 54 passing through the inside of the cathode support portion 37. The cathode 36 may be referred to as an electron generation source. In the cathode 36, an emission position for electron beams coincides with the center of the cathode. The center of the cathode 36 may hereinafter include a straight line passing through the center.

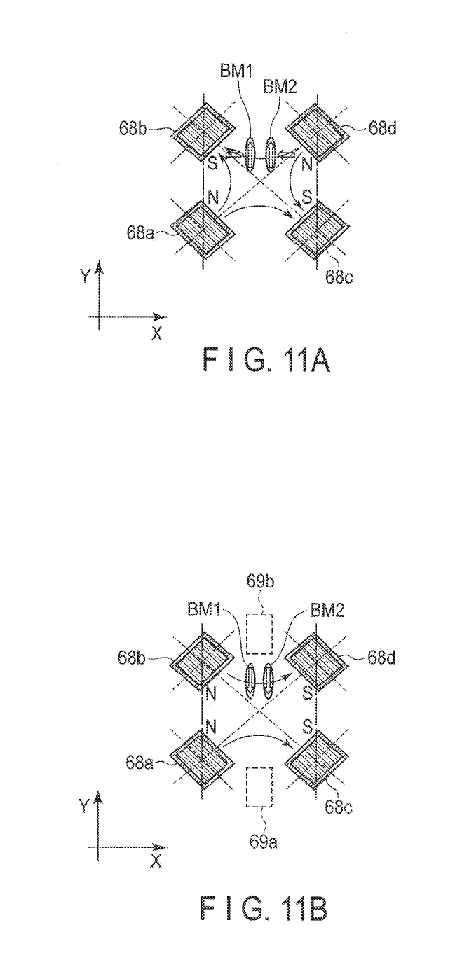

The cathode support portion 37 has a first end portion provided with the cathode 36 and a second end portion provided with the KOV member 55. Furthermore, the cathode 36 is internally provided with the high-voltage supply terminal 54. As shown in FIG. 11A, the cathode support portion 37 is installed so as to extend from the KOV member 55 provided around the tube axis TA to the vicinity of the outer circumference of the anode target 35. Furthermore, the cathode support portion 37 is installed substantially parallel to and at a predetermined distance from the anode target 35. In this case, the cathode support portion 37 is provided with the cathode 36 at an outer circumferential-side end portion of the anode target 35.

The KOV member 55 is formed of a low-expansion alloy. The KOV member 55 has a first end portion joined to the cathode support portion 37 by brazing and a second end portion joined to a high-voltage insulating member 50 by brazing. The KOV member 55 covers the high-voltage supply terminal 54 in the vacuum envelope 31 described below.

The high-voltage supply terminal 54 and the KOV member 55 are joined to the high-voltage insulating member 50. The high-voltage supply terminal 54 penetrates the vacuum container 32 described below and is inserted into the vacuum envelope 31. In this case, the high-voltage supply terminal 54 is inserted into the vacuum envelope 31 with an insertion portion of the high-voltage supply terminal 54 sealed in a vacuum airtight manner.

The high-voltage supply terminal 54 is connected to the cathode 36 through the inside of the cathode support portion 37. The high-voltage supply terminal 54 applies a relatively negative voltage to the cathode 36, while supplying a filament current to the filaments (electron radiation source) of the cathode 36, not shown in the drawings. The high-voltage supply terminal 54 is connected to the receptacle 302 and supplied with a current when a high-voltage supply source such as a plug not shown in the drawings is connected to the receptacle 302. The high-voltage supply terminal 54 is a metal terminal.

The vacuum envelope 31 is sealed in a vacuum atmosphere (vacuum airtight manner) and internally houses the fixed shaft 11, the rotating body 12, the bearing 13, the rotor 14, the vacuum container 32, the anode target 35, the cathode 36, the high-voltage supply terminal 54, and the KOV member 55.

The vacuum container 32 is provided with the X-ray transmission window 38 in a vacuum airtight manner. The X-ray transmission window 38 is provided in the wall portion of the vacuum envelope 31 (vacuum container 32) opposed to an area between the cathode 36 and the anode target 35. The X-ray transmission window 38 is formed of metal, for example, beryllium or titanium, stainless steel, and aluminum and provided in a portion of the vacuum container 32 which is opposed to the X-ray radiation window 20w. For example, the vacuum container 32 is hermetically occluded by the X-ray transmission window 38 formed of beryllium as a member which allows X rays to pass through. In the vacuum envelope 31, the high-voltage insulating member 39 is arranged from the high-voltage supply terminal 44 side to the periphery of the anode target 35. The high-voltage insulating member 39 is formed of an electric insulating resin.

The vacuum envelope 31 (vacuum container 32) is provided with a recessed portion in which a tip portion of the quadrupole magnetic-field generator 60 described below is housed. As shown in FIG. 10B, in the present embodiment, the vacuum envelope 31 (vacuum container 32) is provided with a plurality of recessed portions 32a, 32b, 32c, and 32d. Each of the recessed portions 32a, 32b, 32c, and 32d is formed in a portion of the vacuum envelope 31 (vacuum container 32). That is, each of the recessed portions 32a, 32b, 32c, and 32d is a portion of the vacuum envelope 31 (vacuum container 32) surrounding the recess. For example, the recessed portions 32a to 32d are formed by externally recessing the vacuum envelope 31 (vacuum container 32) in such a manner that the recessed portions 32a to 32d surround the cathode 36 in a direction perpendicular to the emission direction of electron beams. That is, the recessed portions 32a to 32d are formed to protrude parallel to the emission direction of electron beams from the cathode 36 if the vacuum envelope 31 (vacuum container 32) is internally observed.

The recessed portions 32a to 32d are arranged at an even distance from a predetermined central position (recessed portion center). The recessed portions 32a to 32d are arranged, for example, around the cathode 36 at equal angular intervals in such a manner that the center of the recessed portions (recessed portion center) coincides with a position displaced perpendicularly from (located perpendicularly eccentrically to) electron orbits. In this case, the recessed portion 32b is formed at 90° with respect to the recessed portion 32a in a rotating direction (counterclockwise) around the recessed portion center. Similarly, the recessed portion 32d is formed at 90° with respect to the recessed portion 32b in the rotating direction around the center of the cathode 36, and the recessed portion 32c is formed at 90° with respect to the recessed portion 32d in the rotating direction around the center of the cathode 36.

For example, as shown in FIG. 10B, the recessed portion 32a is installed at a position located at 45° from the straight line L1 in the rotating direction around the recessed portion center, the recessed portion 32b is installed at a position resulting from rotation through 90° from the recessed portion 32a in the rotating direction around the center of the cathode 36, the recessed portion 32d is installed at a position resulting from rotation through 90° from the recessed portion 32b in the rotating direction around the center of the cathode 36, and the recessed portion 32c is installed at a position resulting from rotation through 90° from the recessed portion 32d in the rotating direction around the center of the cathode 36. That is, the recessed portions 32a to 32d are installed so as to be arranged at the positions of vertices of a square.

Furthermore, each of the recessed portions 32a to 32d is formed so as to avoid lying excessively proximate to the surface of the anode target 35 and the surface of the cathode 36 in order to prevent discharge and the like. For example, the recessed portion 32a is formed by being recessed to a position farther from the surface of the anode target 35, in a direction along the tube axis TA, than the surface of the cathode 36 opposed to the surface of the anode target 35. Alternatively, the recessed portion 32a is formed by being recessed to the same position as that of the surface of the cathode 36 or a position slightly closer to the surface of the anode target 35, in a direction along the tube axis TA, than to the surface of the cathode 36. Corner portions of the recessed portions 32a to 32d which protrude to the anode target 35 side are each formed so as to be curved or inclined to lie away from the target surface of the anode target 35 and the surface of the cathode 36 in order to prevent discharge and the like. For example, as shown in FIG. 11C, the corner portions of the recessed portions 32a to 32d are each formed like curved surfaces. The corner portions of the recessed portions 32a to 32d may each be inclined at an angle along the inclination angle of each of the magnetic poles 68 (68a, 68b, 68c, and 68d). The corners of the recessed portions 32a to 32d protruding to the anode target 35 side may not be formed to have an inclination and a diameter.

Moreover, the number of the recessed portions may not be four provided that the recessed portions are installed so as to peripherally surround the axis (electron orbits) of the cathode 36 along the emission direction of electron beams. For example, the recessed portions 32a to 32d may be integrally formed. Furthermore, the recessed portions 32a and 32b may be integrally formed, while the recessed portions 32c and 32d may be integrally formed.

Furthermore, the vacuum envelope 31 captures recoil electrons reflected from the anode target 35. Thus, the vacuum envelope 31 is likely to have the temperature thereof raised by the bombardment of recoil electrons and is normally formed of a member such as copper which has a high heat conductivity. The vacuum envelope 31 is desirably constituted of a member which does not generate a diamagnetic field if the vacuum envelope 31 is affected by an AC magnetic field. For example, the vacuum envelope 31 is formed of a metal member which is a nonmagnetic substance. Suitably, the vacuum envelope 31 is formed of a high-electric-resistance member which is a nonmagnetic substance in order to avoid overcurrent resulting from an alternating current. The high-electric-resistance member which is a nonmagnetic substance is, for example, nonmagnetic stainless steel, inconel, inconel X, titanium, conductive ceramics, or non-conductive ceramics the surface of which is coated with a metal thin film. More suitably, the recessed portions 32a to 32d of the vacuum envelope 31 are formed of a high-electric-resistance member which is a nonmagnetic substance, and the whole vacuum envelope 31 except for the recessed portions 32a to 32d is formed of a nonmagnetic member such as copper which has a high heat conductivity.

With reference to FIG. 10B to FIG. 10E, the quadrupole magnetic-field generator 60 will be described below in detail.

As shown in FIG. 10B and FIG. 10E, the quadrupole magnetic-field generator 60 is provided with the coils 64 (64a, 64b, 64c, and 64d), the yoke 66 (66a, 66b, 66c, and 66d), the magnetic poles (68a, 68b, 68c, and 68d), and the polarizing coil portions 69a, 69b.

In the present embodiment, the quadrupole magnetic-field generator 60 is installed in such a manner that the central position thereof is perpendicularly eccentric to the central axis of the cathode 36. For example, as shown in FIG. 10E, in the quadrupole magnetic-field generator 60, four magnetic poles 68 are arranged in a square form. As described below in detail, in the quadrupole magnetic-field generator 60, the magnetic poles 68a, 68b, 68c, and 68d are provided at tips of protruding portions 66a, 66b, 66c, and 66d protruding from the main body portion of the yoke 66.

As schematically shown in FIG. 100 and FIG. 10D, the magnetic pole pair 68a, 68c and the magnetic pole pair 68b, 68d each form a magnetic field between the magnetic poles. In the quadrupole magnetic-field generator 60, a DC current supplied to each of the polarizing coil portions 69a, 69b described below by the power source (not shown in the drawings) is controlled by the polarizing power source control portion (not shown in the drawings). By installing the quadrupole magnetic-field generator 60 in such a manner that the center thereof is perpendicularly eccentric to the central axis of the cathode 36, electron beams in a desired direction are deformed and polarized. For example, as shown in FIG. 10E, the quadrupole magnetic-field generator 60 can deform the electron beams BM1 and BM2 emitted from the filaments 361a and 361b, respectively, so as to reduce the width of each of the electron beams, and can correct, by polarization, movement of the focus on the anode target 35 in the radial direction associated with the deformation of the width. That is, the quadrupole magnetic-field generator 60 can adjust the position of the focus on the surface of the anode target 35 where the electron beams BM1 and BM2 bombard at the same position so as to overlap each other, and can reduce a thermal load on the focus.

Each of the coils 64 is supplied with a current from the power source (not shown in the drawings) for the quadrupole magnetic-field generator 60 to generate a magnetic field. In the present embodiment, each coil 64 is supplied with a direct current from the power source (not shown in the drawings). The coils 64 are provided with a plurality of coils 64a, 64b, 64c, and 64d. Each of the coils 64a to 64d is wound around a portion of a corresponding one of the protruding portions 66a, 66b, 66c, and 66d of the yoke 66 described below.

The yoke 66 is provided with the protruding portions 66a, 66b, 66c, and 66d protruding from the main body portion. The protruding portions 66a to 66d are provided to protrude in a direction parallel to the emission direction (electron orbits) of the electron beams or the central axis of the cathode 36. The protruding portions 66a to 66d protrude in the same direction and are parallel to one another. Furthermore, the protruding portions 66a to 66d are formed to have the same length and shape. Furthermore, in the yoke 66, the main body portion is shaped like a polygon or a hollow cylinder. In the present embodiment, the yoke 66 is installed in such a manner that each of the four protruding portions 66a to 66d is housed in a corresponding one of the recessed portions 32a to 32d. In this case, the yoke 66 is arranged in such a manner that the four protruding portions 66a to 66d surround the cathode 36. Furthermore, the coil 64 is wound around a portion of each of the four protruding portions.

More specifically, the coil 64a is wound around a portion of the protruding portion 66a of the yoke 66, and a portion of the protruding portion 66a around which the coil 64a is not wound is housed in the recessed portion 32a. Similarly, the coils 64b, 64c, and 64d are each wound around a portion of a corresponding one of the protruding portions 66b, 66c, and 66d, and portions of the protruding portions 66b, 66c, and 66d around which the coils 64b, 64c, and 64d, respectively, are not wound are housed in the recessed portions 32b, 32c, and 32d, respectively.

The magnetic poles 68 are provided with the plurality of magnetic poles 68a, 68b, 68c, and 68d. The magnetic poles 68a, 68b, 68c, and 68d are provided at the tip portions of the protruding portions 66a, 66b, 66c, and 66d, respectively, of the yoke 66. The magnetic poles 68a to 68d are arranged to surround the periphery of the cathode 36. That is, in the quadrupole magnetic-field generator 60, the magnetic poles 68a, 68b, 68c, and 68d are arranged at positions perpendicular to the central axis of the cathode 36 and evenly around a predetermined position as a center (magnetic pole center). In this case, the central (magnetic pole center) position of arrangement of the magnetic poles 68a to 68d is an intersection point between straight lines passing through the centers of the magnetic poles 68a to 68d.

For example, as is the case with the above-described recessed portions 32a to 32d, as shown in FIG. 10B, the magnetic pole 68a is installed at a position located at 45° from the straight line L1 in the rotating direction (counterclockwise) around a magnetic pole center C1, the magnetic pole 68b is installed at a position resulting from rotation through 90° from the magnetic pole 68a in the rotating direction around the magnetic pole center C1, the magnetic pole 68d is installed at a position resulting from rotation through 90° from the magnetic pole 68b in the rotating direction around the magnetic pole center C1, and the magnetic pole 68c is installed at a position resulting from rotation through 90° from the magnetic pole 68d in the rotating direction around the magnetic pole center C1. That is, the magnetic poles 68a to 68d are installed so as to be arranged at the positions of vertices of a square.

Suitably, in order to increase the magnetic flux density, the magnetic poles 68a to 68d are installed moderately close to the emission direction (electron orbits) of electrons emitted from the filaments included in the cathode 36. That is, the magnetic pole 68a is arranged in the vicinity of a cathode 36-side curved wall surface of the recessed portions 32a. Similarly, each of the magnetic poles 68b to 68d is arranged in the vicinity of a cathode 36-side curved wall surface of a corresponding one of the recessed portions 32b to 32d. The recessed portions 32a to 32d are arranged so as to avoid lying excessively proximate to the cathode 36 in order to prevent discharge and the like.

The magnetic poles 68a to 68d are formed to have substantially the same shape. The magnetic poles 68a to 68d include two dipoles each forming a pair. For example, the magnetic pole 68a and the magnetic pole 68b are a dipole (magnetic pole pair 68a, 68b), and the magnetic pole 68c and the magnetic pole 68d are a dipole (magnetic pole pair 68c, 68d). In this case, when a direct current is supplied to each magnetic pole 68 via the corresponding coil 64, the magnetic pole pair 68a, 68d and the magnetic pole pair 68c, 68d form opposite DC magnetic fields. Each of the magnetic poles 68a to 68d is installed in such a manner that the surface (end face) thereof faces the magnetic pole center, in order to regulate the shape and direction of each of the electron beams BM1 and BM2 emitted from the filaments 361a and 361c, respectively, with the magnetic flux density made as high as possible with the magnetic poles 68a to 68d avoiding lying excessively close to the anode target 35. In this case, the magnetic poles 68a to 68d are formed in such a manner that the surfaces thereof are opposed to one another.

For example, as shown in FIG. 10B, each of the magnetic poles 68a to 68d is defined by an inclined surface inclined at the same angle to a straight line which passes through the magnetic pole center C1 and which is parallel to the tube axis TA. An inclination angle from the straight line which passes through the magnetic pole center C1 and which is parallel to the tube axis TA to the surface of the magnetic pole 68a is denoted by γ1, and an inclination angle from the straight line which passes through the magnetic pole center C1 and which is parallel to the tube axis TA to the surface of the magnetic pole 68d is denoted by γ4. An inclination angle from the straight line which passes through the magnetic pole center C1 and which is parallel to the tube axis TA to the surface of the magnetic pole 68b is denoted by γ2, and an inclination angle from the straight line which passes through the magnetic pole center C1 and which is parallel to the tube axis TA to the surface of the magnetic pole 68c is denoted by γ3. Therefore, for example, if the magnetic poles 68a to 68d are installed so as to have the same inclination, γ1=γ2=γ3=γ4. In this case, the inclination angles γ (γ1, γ2, γ3, and γ4) of the magnetic poles 68a to 68d are set within the range of 0°<γ<90°. In this case, each of the magnetic poles 68a to 68d is formed in such a manner that the inclination angle γ thereof is set within the range of 0°<γ<90°. For example, if the magnetic poles 68a to 68d have the same inclination angle (γ1=γ2=γ3=γ4), the inclinations γ1, γ2, γ3, and γ4 of the magnetic poles 68a to 68d are formed within the range of 30°≦γ≦60°. Moreover, the inclinations γ1, γ2, γ3, and γ4 of the magnetic poles 68a to 68d may be formed at 45° to the straight line which passes through the magnetic pole center C1 and which is parallel to the tube axis TA.

The polarizing coil portions 69a, 69b (the first polarizing coil portion, the second polarizing coil portion) are electromagnetic coils to which a current is supplied by the power source (not shown in the drawings) and which generate magnetic fields. In the present embodiment, each of the polarizing coil portions 69a, 69b is supplied with a DC power supply from the power source (not shown in the drawings) to generate an AC magnetic field. Each of the polarizing coil portions 69a, 69b is wound between any two of the protruding portions 66a to 66d of the main body portion of the yoke 66. As shown in FIG. 10C and FIG. 10D, the polarizing coil portion 69a is wound around the main body portion of the yoke 66 between the protruding portions 66a and 66c. The polarizing coil portion 69b is wound around the main body portion of the yoke 66 between the protruding portions 66b and 66d. In this case, the magnetic pole pair 68a, 68c generates a DC magnetic field between the magnetic poles 68a and 68c, and the magnetic pole pair 68b, 68d generates a DC magnetic field between the magnetic poles 68b and 68d.

The polarizing coil portions 69a, 69d generate dipole magnetic fields formed along a direction which is perpendicular to the radial direction of the anode target 35 and which extends along the width direction of the filaments included in the cathode 36. The polarizing coil portions 69a, 69b can polarize and move the orbits of electron beams in a predetermined direction.

The principle of the quadrupole magnetic-field generator 60 of the present embodiment will be described below with reference to the drawings.

FIG. 11A is a diagram showing the principle of quadrupole magnetic fields of the third embodiment, and FIG. 11B is a diagram showing the principle of a dipole of the second embodiment. In FIG. 11A and FIG. 11B, the X direction and the Y direction are directions perpendicular to the central axis of the cathode 36, and are orthogonal to each other. Furthermore, the X direction is a direction extending from the magnetic pole 68b (magnetic pole 68a) side toward the magnetic pole 68d (magnetic pole 68c) side, and the Y direction is a direction extending from the magnetic pole 68a (magnetic pole 68c) side toward the magnetic pole 68b (magnetic pole 68d) side.

In FIG. 11A and FIG. 11B, unlike in FIG. 3, FIG. 6, FIG. 8, the electron beam BM1 and the electron beam BM2 are assumed to travel from the side closer to the reader toward the side farther from the reader in the drawing. Furthermore, in FIG. 11A and FIG. 11B, the magnetic pole 68a and the magnetic pole 68c are a dipole forming a pair (magnetic pole pair), and the magnetic pole 68b and the magnetic pole 68d are a dipole forming a pair (magnetic pole pair). The magnetic poles 68a, 68c generate a DC magnetic field traveling in a direction following the X direction, and the magnetic poles 68b, 68d generate a DC magnetic field following the X direction.

As shown in FIG. 11A, if not subjected to the action of the polarizing coil portions 69a, 69b, the quadrupole magnetic-field generator 60 is assumed to generate an N-pole magnetic field at the magnetic pole 68a, generate an S-pole magnetic field at the magnetic pole 68b, generate an S-pole magnetic field at the magnetic pole 68c, and generate an N-pole magnetic field at the magnetic pole 68d.

As shown in FIG. 11B, the polarizing coil portion 69a generates an N-pole magnetic field at the magnetic pole 68a and generates an S-pole magnetic field at the magnetic pole 68c. Similarly, the polarizing coil portion 69b generates an N-pole magnetic field at the magnetic pole 68b and generates an S-pole magnetic field at the magnetic pole 68d. Therefore, a magnetic field traveling from the magnetic pole 68a toward the magnetic pole 68c and a magnetic field traveling from the magnetic pole 68b toward the magnetic pole 68d are formed by the polarizing coil portion 69a and the polarizing coil portion 69b, respectively.

The quadrupole magnetic-field generator 60 is subjected to the action of magnetic fields from the polarizing coil portions 69a, 69b as shown in FIG. 11B to superimpose a magnetic field generated by the polarizing coil portion 69a on a magnetic field traveling from the magnetic pole 68a toward the magnetic pole 68c, while superimposing a magnetic field generated by the polarizing coil portion 69b on a magnetic field traveling from the magnetic pole 68d toward the magnetic pole 68b. Therefore, the quadrupole magnetic-field generator 60 generates superimposed magnetic fields traveling from the magnetic pole 68a toward the magnetic pole 68c in addition to magnetic fields from the quadrupole. Here, the magnetic fields between the magnetic poles 68b and the magnetic pole 68d cancel each other.

In the present embodiment, when the X-ray tube device 1 is driven, the filament 361a and the filament 361b, included in the cathode 36, emit the electron beams BM1 and BM2, respectively, toward the focus of electrons on the anode target 35. Here, the direction in which electrons are emitted is a direction perpendicular to each of the converging surfaces 363a and 363b. Furthermore, the inclinations γ1 to γ4 of the magnetic poles 68a to 68d of the quadrupole magnetic-field generator 60 shown in FIG. 10B are the same. In the quadrupole magnetic-field generator 60, each of the coils 64 is supplied with a direct current from the power source not shown in the drawings. When a direct current from the power source is supplied to the quadrupole magnetic-field generator 60, the quadrupole magnetic-field generator 60 generates magnetic fields among the magnetic poles 68a to 68d, which are a quadrupole. Upon traversing magnetic fields generated between the anode target 35 and the cathode 36 and cathode support portion 37, the electron beams BM1 and the electron beam BM2 emitted from the filaments 361a and 361b of the cathode 36 are focused and polarized in a predetermined direction. As a result, the electron beam BM1 and the electron beam BM2 bombard at the focus on the anode target 35. In the present embodiment, for example, as shown in FIG. 10E, the quadrupole magnetic-field generator 60 acts to deform the electron beams emitted in circles into ellipses which are elongate in the Y direction and to focus each of the electron beams BM1 and BM2 on the central side of the cathode 36 along the straight line L3. In this case, the quadrupole magnetic-field generator 60 can accurately bombard a plurality of electron beams (electron beams BM1 and BM2) at the focus on the anode target 35 surface in such a manner that the electron beams have a small apparent focus.

According to the present embodiment, the X-ray tube device 1 is provided with the X-ray tube 30 provided with the recessed portions 32a to 32d and the quadrupole magnetic-field generator 60 provided with the polarizing coil portions 69a and 6b. When the polarizing coil portions 69a and 69b are supplied with a direct current from the power source, the quadrupole magnetic-field generator 60 can generate superimposed magnetic fields. The quadrupole magnetic-field generator 60 of the first embodiment is installed perpendicularly eccentrically to the orbits of electron beams to achieve polarization in one direction. However, the quadrupole magnetic-field generator 60 of the present embodiment can perform correction by polarizing movement (misalignment, eccentricity) of electron beams in the length direction thereof (Y direction) resulting from deformation of the electron beams in the width direction(X direction). Therefore, the X-ray tube device 1 of the present embodiment can magnetically change the electron beam shape into the optimal shape according to the intended use.

Furthermore, in the X-ray tube device 1 of the present embodiment, the anode target 35 and the cathode 36 are installed more proximate to each other than in the above-described embodiments. Therefore, the X-ray tube device 1 of the present embodiment can reduce possible enlargement of the X-ray focus, a possible blur, possible distortion, a possible decrease in the amount of electrons emitted from the cathode 36, and the like.

The X-ray tube device 1 of the present embodiment may further be provided with the polarizing coil portions 69c, 69d. The polarizing coil portions 69c, 69d (a third polarizing coil portion, a fourth polarizing coil portion) are supplied with a current from the power source (not shown in the drawings) to generate a magnetic field. In the present embodiment, each of the polarizing coil portions 69c, 69d is supplied with a direct current from the power source (not shown in the drawings) to generate a DC magnetic field. Each of the polarizing coil portions 69c, 69d is wound between any two of the protruding portions 66a to 66d of the main body portion of the yoke 66. For example, the polarizing coil portion 69c is wound around the main body portion of the yoke 66 between the protruding portions 66a and 66b. The polarizing coil portion 69d is wound around the main body portion of the yoke 66 between the protruding portions 66c and 66d. In this case, the magnetic pole pair 68a, 68b generates a DC magnetic field between the magnetic poles 68a and 68b, and the magnetic pole pair 68c, 68d generates a DC magnetic field between the magnetic poles 68c and 68d.

The polarizing coil portions 69c, 69d generate a dipole magnetic field formed along a direction along the length direction perpendicular to the width direction of the filaments included in the cathode 36, which is the radial direction of the anode target 35. The polarizing coil portions 69c, 69d can polarize and move the orbits of electron beams in a predetermined direction.

In the present embodiment, the quadrupole magnetic-field generator 60 may be provided with the polarizing coil portions 69a, 69b, 69c, and 69d. In this case, each of the polarizing coil portions 69a to 69d may be supplied with an alternating current. In such a case, the quadrupole magnetic-field generator 60 generates a dipole AC magnetic fields in such a manner that magnetic fields generated from two pairs of magnetic poles act in the same direction.

If each of the polarizing coil portions 69a and 69b is supplied with an alternating current, for example, the quadrupole magnetic-field generator 60 is provided with the magnetic pole 68a and the magnetic pole 68c forming a pair and the magnetic pole 68b and the magnetic pole 68d forming a pair. The magnetic pole pair 68a, 68c and the magnetic pole pair 68b, 68d each serve as a dipole to form a magnetic field. The magnetic pole pair 68a, 68c and the magnetic pole pair 68b, 68d each form an AC magnetic field between the magnetic poles.

If each of the polarizing coil portions 69c and 69d is supplied with an alternating current, for example, the quadrupole magnetic-field generator 60 is provided with the magnetic pole 68a and the magnetic pole 68b forming a pair and the magnetic pole 68c and the magnetic pole 68d forming a pair. The magnetic pole pair 68a, 68b and the magnetic pole pair 68c, 68d each serve as a dipole to form a magnetic field. The magnetic pole pair 68a, 68b and the magnetic pole pair 68c, 68d each form an AC magnetic field between the magnetic poles.

The quadrupole magnetic-field generator 60 can intermittently or continuously polarize the orbits of electrons based on an AC magnetic field generated between the magnetic poles of the dipole as a result of supply of an alternating current. An alternating current from the power source (not shown in the drawings) supplied to each of the polarizing coil portions 69a to 69d described below is controlled by the polarizing power source control portion (not shown in the drawings) so as to intermittently or continuously move the focus bombarded by electron beams emitted from the cathode 36. The quadrupole magnetic-field generator 60 can polarize electron beams emitted from the cathode 36 in a direction along the radial direction of the anode target 35. That is, the quadrupole magnetic-field generator 60 can move the position of the focus on the surface of the anode target 35 bombarded by the electron beams.

Moreover, the X-ray tube device 1 of the present embodiment is provided with the first quadrupole magnetic-field generator provided with the polarizing coil portions 69a and 69b and the second quadrupole magnetic-field generator provided with the polarizing coil portions 69c and 69d. In this case, the quadrupole magnetic-field generator 60 can polarize electron beams emitted from the cathode 36 in any direction of the anode target 35.

According to the above-described embodiments, the X-ray tube device 1 is provided with an X-ray tube provided with a plurality of recessed portions and a quadrupole magnetic-field generator which forms electron beams emitted by the X-ray tube. In the quadrupole magnetic-field generator, a direct current from the power source is supplied to coils to generate magnetic fields between a plurality of magnetic poles.

In the quadrupole magnetic-field generator, electron beams emitted from the cathode can be deformed by magnetic fields generated by the plurality of magnetic poles. As a result, the X-ray tube device 1 of the present embodiment can reduce possible enlargement of the X-ray focus, a possible blur, possible distortion, a possible decrease in the amount of electrons emitted from the cathode 36, and the like.

In the above-described embodiment, the X-ray tube device 1 is a rotating anode type X-ray tube, but may be a fixed anode type X-ray tube.

In the above-described embodiments, the X-ray tube device 1 is a neutral grounding type X-ray tube device, but may be an anode grounding type or cathode grounding type X-ray tube device.

Moreover, in the above-described embodiments, the anode 36 is provided with a nonmagnetic cover surrounding the outer circumferential portion of the anode 36, but may have an integral structure and may all be formed of a nonmagnetic substance or a metal of a nonmagnetic substance with a high electric conductivity.

Furthermore, in the above-described embodiments, the surface of the cathode 36 opposed to the anode target 35 is provided with an inclined portion, and the inclined portion is provided with a plurality of electron generation sources. However, the surface of the cathode 36 opposed to the anode target 35 may have no inclined portion and may be a flat portion provided with a plurality of electron generation sources.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray tube device comprising:
an anode target comprising a target surface bombarded by electrons to generate X rays and a cathode comprising a plurality of electron generation sources configured to emit the electrons;
a vacuum envelope configured to house the cathode and the anode target and internally sealed in a vacuum airtight manner; and
a quadrupole magnetic-field generator configured to form a magnetic field by being supplied with a current from a power source, the quadrupole magnetic-field generator being installed on an outer side of the vacuum envelope and constituted of a quadrupole surrounding a periphery of electron orbits of the electrons emitted simultaneously from each of the plurality of electron generation sources.

2. The X-ray tube device of claim 1, wherein
the quadrupole magnetic-field generator is installed perpendicularly eccentrically to a central axis of the cathode.

3. The X-ray tube device of claim 1, wherein
the vacuum envelope further comprises a housing portion configured to extend outward at a position opposed to the anode target and to house the cathode, the housing portion comprising a small diameter portion formed between the anode target and the cathode and having a smaller diameter than surrounding parts, and
the quadrupole magnetic-field generator is arranged to surround a periphery of the small diameter portion.

4. The X-ray tube device of claim 1, wherein
the vacuum envelope comprises recessed portions recessed with respect to the outer side, and the four poles of the quadrupole are housed in the recessed portions.

5. The X-ray tube device of claim 1, further comprising
at least one polarizing coil portion supplied with a direct current from a DC power source and provided in a portion of the quadrupole magnetic-field generator, the polarizing coil portion forming, in the quadrupole magnetic-field generator, at least a pair of dipoles configured to generate DC magnetic fields at the four poles of the quadrupole.

6. The X-ray tube device of claim 5, further comprising at least one polarizing coil portion supplied with an alternating current from an AC power source and provided in a part of the quadrupole magnetic-field generator, the polarizing coil portion forming, in the quadrupole magnetic-field generator, at least a pair of dipoles configured to generate AC magnetic fields at the four poles.

7. The X-ray tube device of claim 6, wherein
the cathode and the target surface further comprise a cathode support portion at least a surface portion of which is formed of a metal member which has a high electric conductivity and which is a nonmagnetic substance, the cathode support portion being housed in the vacuum envelope and configured to support the cathode provided at a position opposed to the anode target.

8. The X-ray tube device of claim 7, wherein
the metal member is one of copper, tungsten, molybdenum, niobium, tantalum, and nonmagnetic stainless steel, or a metal material a principal ingredient of which is one of copper, tungsten, molybdenum, niobium, tantalum, and nonmagnetic stainless steel.

9. The X-ray tube device of claim 4, wherein
end faces of the four poles of the quadrupole of the quadrupole magnetic-field generator are each provided in such a manner that an angle of the end face to the electron orbits is a predetermined inclination angle γ, and
the inclination angle γ is 0°<γ<90°.
